(19) United States
(12) Patent Application Publication
(10) Pub. No.: US 2025/0071737 A1
(43) Pub. Date: Feb. 27, 2025

(54) TECHNIQUES FOR UPLINK CARRIER AGGREGATION COMMUNICATIONS

(71) Applicant: QUALCOMM Incorporated, San Diego, CA (US)

(72) Inventors: Akash KUMAR, Hyderabad (IN); Brahim SAADI, Nuremberg (DE); Hargovind Prasad BANSAL, Hyderabad (IN)

(21) Appl. No.: 18/455,477

(22) Filed: Aug. 24, 2023

(51) Int. Cl. H04W 72/044; H04L 5/00; H04W 72/23

(52) U.S. Cl. CPC H04W 72/044; H04L 5/0057; H04W 72/23

(57) ABSTRACT

Methods, systems, and devices for wireless communications are described. A user equipment (UE) may receive a power reduction configuration associated with uplink communications performed by the UE within aggregated carriers, and a resource allocation for communicating one or more uplink messages across multiple aggregated carriers (e.g., uplink carrier aggregation (ULCA)). The UE may evaluate power reduction values that are to be used for the multiple aggregated carriers based on the power reduction configuration, and may determine throughput contributions for each respective carrier. Based on the power reduction values and the throughput contributions of the respective carriers, the UE may determine whether to continue operating according to the resource configuration for ULCA, or to revert to single-carrier communications.

### FIELD OF TECHNOLOGY

The following relates to wireless communications, including techniques for uplink carrier aggregation (ULCA) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless networks, wireless devices (e.g., UEs) may be scheduled to perform intra-band uplink carrier aggregation (ULCA). In the context of UCLA communications, resources may be aggregated across multiple carriers within the same band (e.g., a resource allocation includes resources within a first component carrier (CC) and a second CC). By allocating resources across multiple carriers, ULCA communications may increase uplink data capacity and throughput.

### SUMMARY

The described techniques relate to improved methods, systems, devices, and apparatuses that support techniques for ULCA communications. Generally, aspects of the present disclosure are directed to techniques that enable wireless devices (e.g., UEs) that are scheduled to perform ULCA communications across multiple CCs to drop down or revert to performing communications using a single CC. In particular, techniques described herein may enable UEs to drop down to single-CC communications when such single-CC communications exhibit higher performance (e.g., higher throughput) as compared to ULCA communications scheduled across multiple CCs.

A method for wireless communications by a UE is described. The method may include receiving, from a network entity, control signaling indicating a power reduction configuration associated with uplink communications performed by the UE within aggregated carriers, receiving, via the control signaling, additional control signaling, or both, a resource allocation for communicating one or more uplink messages across a set of multiple transmission time intervals (TTIs) within a first carrier and a second carrier, where the resource allocation includes a first set of resources within the first carrier and a second set of resources within the second carrier, and transmitting, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI.

A UE for wireless communications is described. The UE may include one or more memories storing processor executable code, and one or more processors coupled with the one or more memories. The one or more processors may individually or collectively operable to execute the code to cause the UE to receive, from a network entity, control signaling indicating a power reduction configuration associated with uplink communications performed by the UE within aggregated carriers, receive, via the control signaling, additional control signaling, or both, a resource allocation for communicating one or more uplink messages across a set of multiple TTIs within a first carrier and a second carrier, where the resource allocation includes a first set of resources within the first carrier and a second set of resources within the second carrier, and transmit, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI.

Another UE for wireless communications is described. The UE may include means for receiving, from a network entity, control signaling indicating a power reduction configuration associated with uplink communications performed by the UE within aggregated carriers, means for receiving, via the control signaling, additional control signaling, or both, a resource allocation for communicating one or more uplink messages across a set of multiple TTIs within a first carrier and a second carrier, where the resource allocation includes a first set of resources within the first carrier and a second set of resources within the second carrier, and means for transmitting, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI.

A non-transitory computer-readable medium storing code for wireless communications is described. The code may include instructions executable by a processor to receive, from a network entity, control signaling indicating a power reduction configuration associated with uplink communications performed by the UE within aggregated carriers, receive, via the control signaling, additional control signaling, or both, a resource allocation for communicating one or more uplink messages across a set of multiple TTIs within a first carrier and a second carrier, where the resource allocation includes a first set of resources within the first carrier and a second set of resources within the second carrier, and transmit, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI.

Some examples of the method, UEs, and non-transitory computer-readable medium described herein may further include operations, features, means, or instructions for transmitting the one or more uplink messages within the first carrier in accordance with a second power reduction value that may be different from the power reduction value based on refraining from transmitting within the second set of resources.

In some examples of the method, UEs, and non-transitory computer-readable medium described herein, the second power reduction value may be associated with a higher transmit power as compared to the power reduction value.

Some examples of the method, UEs, and non-transitory computer-readable medium described herein may further include operations, features, means, or instructions for transmitting the one or more uplink messages within the first set of resources, and refraining from transmitting within the second set of resources, may be based on the power reduction value of the first carrier being greater than or equal to a power reduction threshold.

Some examples of the method, UEs, and non-transitory computer-readable medium described herein may further include operations, features, means, or instructions for transmitting the one or more uplink messages within the first set of resources, and refraining from transmitting within the second set of resources, may be based on the first throughput contribution associated with the first carrier being greater than a second throughput contribution associated with the second carrier during the first TTI of the set of multiple TTIs.

In some examples of the method, UEs, and non-transitory computer-readable medium described herein, the first throughput contribution and the second throughput contribution may be based on quantities of resource blocks included within the first set of resources and the second set of resources, respectively, a modulation and coding scheme (MCS) associated with the first carrier or the second carrier, a block error rate (BLER) associated with the first carrier or the second carrier, or any combination thereof.

Some examples of the method, UEs, and non-transitory computer-readable medium described herein may further include operations, features, means, or instructions for receiving, via the control signaling, the additional control signaling, or both, an indication of the power reduction threshold.

Some examples of the method, UEs, and non-transitory computer-readable medium described herein may further include operations, features, means, or instructions for receiving, via the control signaling, the additional control signaling, or both, an indication of the uplink throughput threshold.

Some examples of the method, UEs, and non-transitory computer-readable medium described herein may further include operations, features, means, or instructions for transmitting, during a second TTI of the set of multiple TTIs, one or more additional uplink messages within the first set of resources of the first carrier and the second set of resources of the second carrier based on a second throughput contribution of the first set of resources failing to satisfy the uplink throughput threshold, an additional uplink throughput threshold, or both, for the second TTI, based on a power reduction value of the first carrier failing to satisfy a power reduction threshold for the second TTI, or both.

In some examples of the method, UEs, and non-transitory computer-readable medium described herein, the uplink throughput threshold associated with the first TTI may be selectively adjusted to the additional uplink throughput threshold based on the UE refraining from transmitting within the second set of resources of the second carrier during the first TTI.

In some examples of the method, UEs, and non-transitory computer-readable medium described herein, the additional uplink throughput threshold evaluated during the second TTI may be different from the uplink throughput threshold evaluated during the first TTI based on one or more parameters associated with the one or more uplink messages scheduled to be communicated within the first TTI and the second TTI.

In some examples of the method, UEs, and non-transitory computer-readable medium described herein, the one or more parameters include a redundancy version (RV) associated with the one or more uplink messages scheduled to be communicated within second TTI.

Some examples of the method, UEs, and non-transitory computer-readable medium described herein may further include operations, features, means, or instructions for transmitting a request for the network entity to adjust the resource allocation based on refraining from transmitting within the second set of resources and receiving a second resource allocation from the network entity based on the request, where the second resource allocation includes resources within a single carrier, or includes resources within the first carrier and a third carrier.

A method for wireless communications by a UE is described. The method may include receiving, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources, transmitting, to the network entity, an uplink message indicating a radio link failure associated with the second carrier based on the second throughput contribution of the second carrier failing to satisfy an uplink throughput threshold, and based on a downlink contribution of the second carrier failing to satisfy a downlink throughput threshold, and transmitting the one or more uplink messages within the first set of resources of the first carrier based on the resource allocation and the uplink message.

A UE for wireless communications is described. The UE may include one or more memories storing processor executable code, and one or more processors coupled with the one or more memories. The one or more processors may individually or collectively operable to execute the code to cause the UE to receive, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources, transmit, to the network entity, an uplink message indicating a radio link failure associated with the second carrier based on the second throughput contribution of the second carrier failing to satisfy an uplink throughput threshold, and based on a downlink contribution of the second carrier failing to satisfy a downlink throughput threshold, and transmit the one or more uplink messages within the first set of resources of the first carrier based on the resource allocation and the uplink message.

Another UE for wireless communications is described. The UE may include means for receiving, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources, means for transmitting, to the network entity, an uplink message indicating a radio link failure associated with the second carrier based on the second throughput contribution of the second carrier failing to satisfy an uplink throughput threshold, and based on a downlink contribution of the second carrier failing to satisfy a downlink throughput threshold, and means for transmitting the one or more uplink messages within the first set of resources of the first carrier based on the resource allocation and the uplink message.

A non-transitory computer-readable medium storing code for wireless communications is described. The code may include instructions executable by a processor to receive, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources, transmit, to the network entity, an uplink message indicating a radio link failure associated with the second carrier based on the second throughput contribution of the second carrier failing to satisfy an uplink throughput threshold, and based on a downlink contribution of the second carrier failing to satisfy a downlink throughput threshold, and transmit the one or more uplink messages within the first set of resources of the first carrier based on the resource allocation and the uplink message.

Some examples of the method, UEs, and non-transitory computer-readable medium described herein may further include operations, features, means, or instructions for receiving, via the control signaling, additional control signaling, or both, a power reduction configuration associated with uplink communications performed by the UE within aggregated carriers, where transmitting the uplink message indicating the radio link failure may be based on a power reduction value of the first carrier being greater than or equal to a power reduction threshold.

Some examples of the method, UEs, and non-transitory computer-readable medium described herein may further include operations, features, means, or instructions for transmitting the one or more uplink messages within the first set of resources of the first carrier in accordance with a second power reduction value that may be different from the power reduction value based on transmitting the uplink message indicating the radio link failure associated with the second carrier.

In some examples of the method, UEs, and non-transitory computer-readable medium described herein, the second power reduction value may be associated with a higher transmit power as compared to the power reduction value.

Some examples of the method, UEs, and non-transitory computer-readable medium described herein may further include operations, features, means, or instructions for receiving, via the control signaling, the additional control signaling, or both, an indication of the power reduction threshold, where transmitting the uplink message indicating the radio link failure may be based on receiving the indication of the power reduction threshold.

Some examples of the method, UEs, and non-transitory computer-readable medium described herein may further include operations, features, means, or instructions for receiving, via the control signaling, additional control signaling, or both, an indication of the uplink throughput threshold, the downlink throughput threshold, or both, where transmitting the uplink message indicating the radio link failure may be based on receiving the indication of the uplink throughput threshold, the downlink throughput threshold, or both.

In some examples of the method, UEs, and non-transitory computer-readable medium described herein, the uplink message includes a channel quality information report associated with the second carrier.

In some examples of the method, UEs, and non-transitory computer-readable medium described herein, the uplink message indicates the radio link failure for each of the set of multiple TTIs.

In some examples of the method, UEs, and non-transitory computer-readable medium described herein, transmitting the uplink message indicating a radio link failure may include operations, features, means, or instructions for transmitting one or more sounding reference signals with a degraded transmit power via one or more resource blocks associated with the second carrier.

### BRIEF DESCRIPTION OF THE DRAWINGS

FIG. 1 shows an example of a wireless communications system that supports techniques for ULCA communications in accordance with one or more aspects of the present disclosure.

FIG. 2 shows an example of a wireless communications system that supports techniques for ULCA communications in accordance with one or more aspects of the present disclosure.

FIG. 3 shows an example of a process flow that supports techniques for ULCA communications in accordance with one or more aspects of the present disclosure.

FIG. 4 shows an example of a process flow that supports techniques for ULCA communications in accordance with one or more aspects of the present disclosure.

FIGS. 5 and 6 show diagrams of devices that support techniques for ULCA communications in accordance with one or more aspects of the present disclosure.

FIG. 7 shows a diagram of a communications manager that supports techniques for ULCA communications in accordance with one or more aspects of the present disclosure.

FIG. 8 shows a diagram of a system including a device that supports techniques for ULCA communications in accordance with one or more aspects of the present disclosure.

FIGS. 9 and 10 show flowcharts illustrating methods that support techniques for ULCA communications in accordance with one or more aspects of the present disclosure.

### DETAILED DESCRIPTION

In some wireless networks, wireless devices (e.g., UEs) may be scheduled to perform intra-band ULCA. In the context of UCLA communications, resources may be aggregated across multiple carriers within the same band (e.g., a resource allocation includes resources within a first CC and a second CC). By allocating resources across multiple carriers, ULCA communications may increase uplink data capacity and throughput. In order to prevent ULCA communications from causing significant in-band and out-of-band interference, UEs scheduled to perform ULCA communications may be expected to apply maximum power reduction (MPR) values to limit transmit (Tx) power associated with the ULCA communications. However, application of high MPR values may significantly reduce the transmit (Tx) power of the ULCA communications performed at the UE, which may reduce the effective range of uplink communications, result in a loss of network coverage, and decrease uplink data throughput.

As such, even though ULCA communications are intended to increase uplink data capacity and throughput, the application of high MPR values may result in situations where the ULCA communications actually result in lower data capacity and/or lower data throughput (and/or loss of network coverage) as compared to single-CC communications. In other words, depending on network conditions and the MPR values that are to be applied, there may be situations where single-CC communications may result in higher uplink data capacity/throughput than multi-CC ULCA communications.

Accordingly, aspects of the present disclosure are directed to techniques that enable wireless devices (e.g., UEs) that are scheduled to perform ULCA communications across multiple CCs to drop down or revert to performing communications using a single CC. In particular, techniques described herein may enable UEs to drop down to single-CC communications when such single-CC communications exhibit higher performance (e.g., higher throughput) as compared to ULCA communications scheduled across multiple CCs.

For example, a UE receives a ULCA resource allocation scheduling resources for ULCA communications across a first CC (CC1) and a second CC (CC2). The UE may also receive an MPR configuration defining MPR values for different types of ULCA resource allocations. The UE may evaluate throughput contributions for the respective CCs, and may determine which MPR value to apply for the ULCA communications based on the MPR configuration. If the throughput contribution of the higher-priority CC is greater than a threshold, and if the MPR value is greater than a threshold, the UE may identify that single-CC communications on the higher-priority CC may exhibit better performance as compared to the ULCA communications across the multiple CCs. As such, the UE may refrain from transmitting on the lower priority CC, and may transmit the messages on the higher-priority CC using a non-ULCA MPR value (which is lower than the MPR value defined in the MPR configuration for the ULCA communications). The UE may perform such an analysis on a per-TTI basis to determine whether the UE will perform ULCA communications (or single-CC communications) within each TTI. Additionally, or alternatively, if the UE determines that single-CC communications are expected to exhibit better performance than ULCA communications, the UE may transmit reports and/or requests to influence the network to schedule different CCs for ULCA communications, and/or to schedule the UE with single-CC communications.

Aspects of the disclosure are initially described in the context of wireless communications systems. Additional aspects of the disclosure are described in the context of example process flows. Aspects of the disclosure are further illustrated by and described with reference to apparatus diagrams, system diagrams, and flowcharts that relate to techniques for ULCA communications.

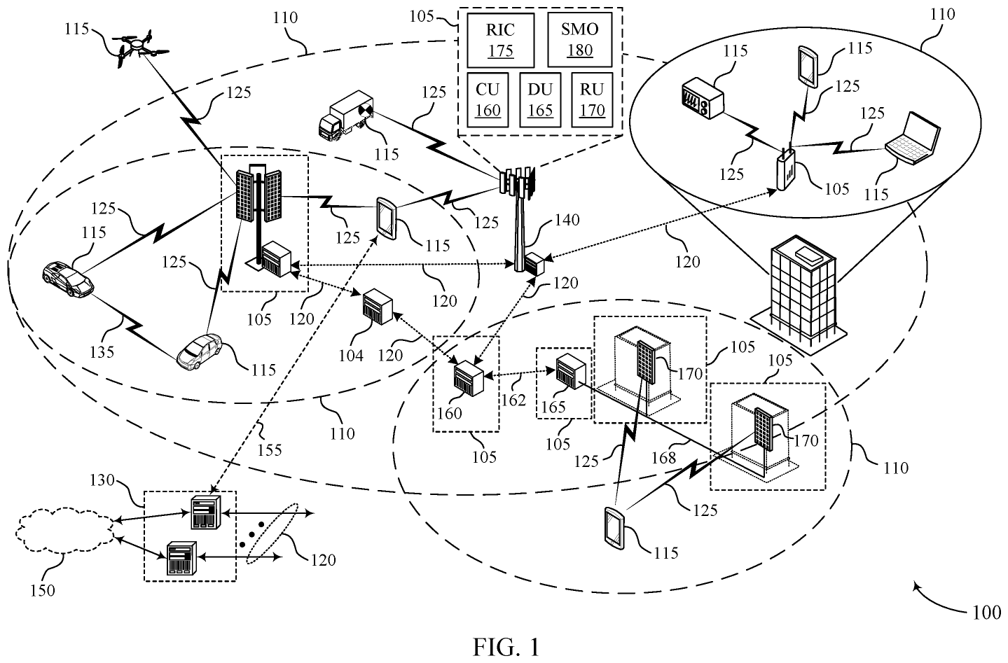

FIG. 1 shows an example of a wireless communications system 100 that supports techniques for ULCA communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for ULCA communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a TTI. In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UEs 115, network entities 105, and other wireless devices of the wireless communications system 100 may be configured to support techniques that enable wireless devices (e.g., UEs 115) that are scheduled to perform ULCA communications across multiple CCs to drop down or revert to performing communications using a single CC. In particular, techniques described herein may enable UEs 115 of the wireless communications system 100 to drop down to single-CC communications when such single-CC communications exhibit higher performance (e.g., higher throughput) as compared to ULCA communications scheduled across multiple CCs.

For example, a UE 115 receives a ULCA resource allocation scheduling resources for ULCA communications across a first CC (CC1) and a second CC (CC2). The UE 115 may also receive an MPR configuration defining MPR values for different types of ULCA resource allocations. The UE 115 may evaluate throughput contributions for the respective CCs, and may determine which MPR value to apply for the ULCA communications based on the MPR configuration. If the throughput contribution of the higher-priority CC is greater than a threshold, and if the MPR value is greater than a threshold, the UE 115 may identify that single-CC communications on the higher-priority CC may exhibit better performance as compared to the ULCA communications across the multiple CCs. As such, the UE 115 may refrain from transmitting on the lower priority CC, and may transmit the messages on the higher-priority CC using a non-ULCA MPR value (which is lower than the MPR value defined in the MPR configuration for the ULCA communications). The UE 115 may perform such an analysis on a per-TTI basis to determine whether the UE will perform ULCA communications (or single-CC communications) within each TTI. Additionally, or alternatively, if the UE 115 determines that single-CC communications are expected to exhibit better performance than ULCA communications, the UE may transmit reports and/or requests to influence the network to schedule different CCs for ULCA communications, and/or to schedule the UE 115 with single-CC communications.

Techniques descried herein may enable more efficient and effective ULCA communications. In particular, techniques described herein may enable UEs 115 to perform ULCA communications when such ULCA communications result in increased throughput and/or uplink data capacity, but to drop back down to single-carrier communications (and/or modified ULCA configurations) when such ULCA communications require high MPR values that restrict network coverage or uplink throughput/capacity. As such, aspects of the present disclosure enable more dynamic ULCA communications where wireless devices are able to evaluate whether or not such ULCA communications will result in increased throughput or performance.

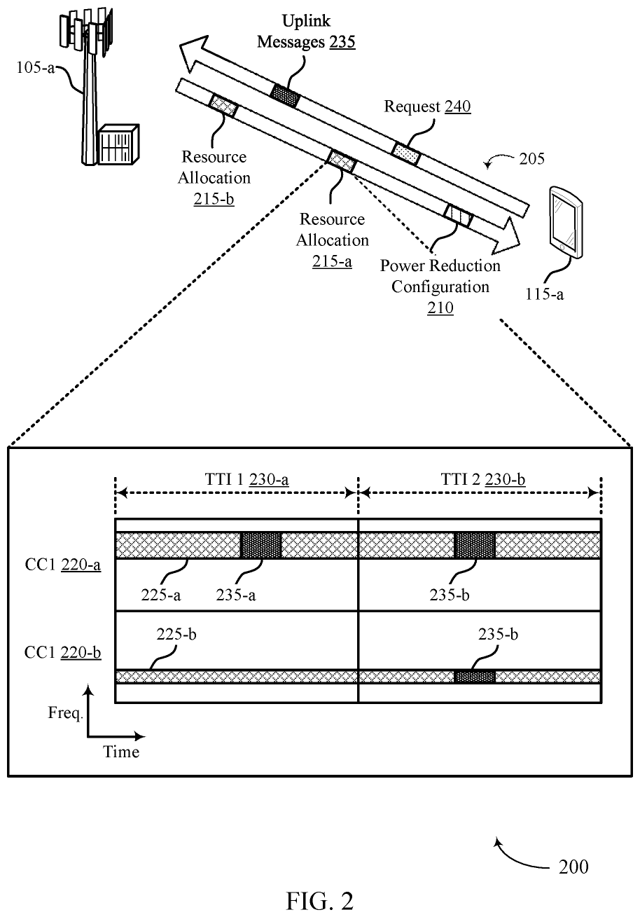

FIG. 2 shows an example of a wireless communications system 200 that supports techniques for ULCA communications in accordance with one or more aspects of the present disclosure. Aspects of the wireless communications system 200 may implement, or be implemented by, aspects of the wireless communications system 100. For example, the wireless communications system 200 illustrates signaling and configurations that enable more dynamic ULCA communications configurations, as described previously herein.

The wireless communications system 200 may include a UE 115-a and a network entity 105-b, which may be examples of UEs 115, network entities 105, and other wireless devices as described with reference to FIG. 1. In some aspects, the UE 115-a may communicate with the network entity 105-a via a communication link 205. In some cases, the communication link 205 may include an example of an access link (e.g., Uu link). The communication link 205 may include a bi-directional link that can include both uplink and downlink communication. For example, the UE 115-a may transmit uplink transmissions, such as uplink control signals or uplink data signals, to the network entity 105-a using the communication link 205, and the network entity 105-a may transmit downlink transmissions, such as downlink control signals or downlink data signals, to the UE 115-a using the communication link 205.

In some implementations, the wireless communications system 200 may be configured to support ULCA communications (e.g., intra-band ULCA). Intra-band ULCA is a form of uplink carrier aggregation where two or more carriers within the same band are aggregated to improve data capacity. The wireless communications system 200 may be configured to support different types or classes (e.g., Class B, Class C) of ULCA communications, depending on capabilities of the UE 115. In the context of UCLA communications, resources may be aggregated across multiple carriers within the same band (e.g., a resource allocation includes resources within a first CC and a second CC). By allocating resources across multiple carriers, ULCA communications may increase uplink data capacity and throughput.

In the context of ULCA communications, specific RB allocations on the multiple uplink carriers may cause significant challenges in meeting in-band and out-of-band RF conformance and performance requirement. As such, in order to prevent ULCA communications from causing significant in-band and out-of-band interference, UEs 115 scheduled to perform ULCA communications may be expected to apply power reduction values (e.g., MPR values) to limit Tx power associated with the ULCA communications. However, application of high MPR values may significantly reduce the Tx power of the ULCA communications performed at the UE 115, which may reduce the effective range of uplink communications, result in a loss of network coverage, and decrease uplink data throughput.

For example, Table 1 below illustrates an MPR configuration for intra-band contiguous carrier aggregation communications (NR carrier bandwidth part (NCRB)). In some cases, the MPR configuration illustrated in Table 1 may be signaled by the network, and/or defined in relevant standards associated with the wireless communications system 200. Table 1 below defines various power reduction values (e.g., MPR values) that are to be applied for ULCA communications based on the applicable modulation scheme. In particular, Table 1 defines different MPR values that are to be applied to inner RBs, an outer RB (Outer1¹), and outer two RBs (Outer2²) of a resource allocation for ULCA communications.

TABLE 1
MPR Configuration for Intra-Band Contiguous Carrier Aggregation

| | | | MPR for BW Class B (dB) | | | MPR for BW Class B (dB) | | |
|---|---|---|---|---|---|---|---|---|
| Modulation | | | Inner | Outer1¹ | Outer2² | Inner | Outer1¹ | Outer2² |
| DFT-s-OFDM | Pi/w BPSK | | 2 | 5.5 | 11.5 | 2.5 | 6 | 13 |
| | QPSK | | 2 | 5.5 | | 2.5 | 6 | |
| | 16 | QAM | 2.5 | 5.5 | | 3 | 6 | |
| | 64 | QAM | 4.5 | 6 | | 5 | 6 | |
| | 256 | QAM | 6 | 6.5 | | 6.5 | 6.5 | |
| CP-OFDM | QPSK | | 2.5 | 6.5 | 12 | 3.5 | 7 | 14 |
| | 16 | QAM | 3 | 7 | | 3.5 | 7 | |
| | 64 | QAM | 5 | 7 | | 5 | 7 | |
| | 256 | QAM | 7.5 | 7.5 | | 7.5 | 7.5 | |

The MPR configuration illustrated in Table 1 above results in significantly higher MPR values (and therefore lower device maximum Tx power level (MTPL)) as compared to MPR values that are to be applied for single-CC communications. This is particularly the case for higher modulation schemes (e.g., 64 QAM and 256 QAM) and Outer2² RB allocations, as shown in Table 1 above.

As such, even though ULCA communications are intended to increase uplink data capacity and throughput, the application of high MPR values may result in situations where the ULCA communications actually result in lower data capacity and/or lower data throughput (and/or loss of network coverage) as compared to single-CC communications. In other words, depending on network conditions and the MPR values that are to be applied, there may be situations where single-CC communications may result in higher uplink data capacity/throughput than multi-CC ULCA communications.

Accordingly, aspects of the present disclosure are directed to techniques that enable wireless devices (e.g., UEs 115) that are scheduled to perform ULCA communications across multiple CCs to drop down or revert to performing communications using a single CC. In particular, techniques described herein may enable UEs 115 to drop down to single-CC communications when such single-CC communications exhibit higher performance (e.g., higher throughput) as compared to ULCA communications scheduled across multiple CCs. Stated differently, aspects of the present disclosure are directed to signaling, configurations, and techniques that enable UEs 115 to intelligently detect scenarios where ULCA communications will lead to significant performance deterioration, and take suitable action to achieve better performance in intra-band ULCA cases.

The UE 115-a may be configured to evaluate ULCA communications (and potentially drop back to single-CC communications) in accordance with multiple implementations. For example, the UE 115-a may be configured to evaluate ULCA communications in accordance with (1) a first implementation for dynamically pruning communications on one or more CCs, and/or (2) a second implementation that exhibits a more static fallback to single-CC communications. For the purposes of the present disclosure, a wireless device may be said to “prune” communications on a CC by refraining from transmitting the scheduled communications on the respective CC.

In some cases, the UE 115-a may be pre-configured to implement the first implementation or the second implementation (e.g., based on UE 115-a capabilities), and the UE 115-a may indicate to the network entity 105-a which implementation will be used. In other cases, the network 105-a may instruct the UE 115-a to implement one of the first or second implementations. Each of the respective implementations will be described in further detail herein.

In accordance with the first implementation for dynamic pruning, upon receiving a resource allocation 215-a for ULCA communications across two (or more) carriers 220-a, 220-b, the UE 115-a may be configured to check the RB allocation on the two (or more) carriers 220. The UE 115-a may determine the RB allocation type of this intra-CC resource allocation (e.g., resource allocation 215-a) and the associated MPR value(s) for performing uplink communications across the carriers 220. The UE 115-a may further check the uplink throughput contribution from each carrier 220 over the currently-evaluated TTI, where the uplink throughput contribution for the respective carriers 220 may be based on a number of factors or parameters, such as the quantity of RBs scheduled within the respective carriers 220 via the resource allocation 215-a, an MCS of the resource allocation, a BLER metric (e.g., an average BLER) of the respective carriers 220, etc. In accordance with the first implementation (e.g., dynamic pruning implementation), the UE 115-a may further check if the carrier 220 with the higher uplink throughput contribution (designated as higher the “higher-priority carrier”) is getting power limited based on the applicable power reduction/MPR value (and if the average BLER of the higher-priority carrier 220 is greater than some threshold) due to the higher MPR associated with the intra-CC RB allocation types. If the proportional uplink throughput contribution of the higher-priority carrier 220 is greater than some threshold, and if the higher-priority carrier 220 is being power limited (e.g., MPR greater than some threshold), then the UE 115-a may be configured to prune the UL DCI of the lower-priority carrier 220. In other words, if such conditions are met, the UE 115-a, may be configured to refrain from transmitting messages on the lower-priority carrier within the current TTI.

In accordance with the first implementation, the UE 115-a may be configured to autonomously prune communications on the lower-priority carrier 220. Stated differently, in some cases, the network entity 105-a may not know that the UE 115-a will prune communications, and may therefore expect communications on both the respective carriers 220. In such cases, upon receiving communications within the first carrier 220, but not the second carrier 220, the network entity 105-a may be configured to recognize that the UE 115-a is pruning communications, and the network entity 105-a may be configured to selectively adjust scheduled communications to reduce or prevent the UE 115-a from pruning future communications. In additional or alternative implementations, the network entity 105-a may be configured to perform the same or complementary analysis described herein in order to determine whether or not the UE 115-a is expected to prune communications on one of the carriers.

The first implementation for dynamic carrier 220 pruning may allow the UE 115-a to preserve the performance of the higher-priority carrier 220 in scenarios where the higher-priority carrier 220 would be power-limited (due to high MPR values for ULCA communications), and where the UE 115-a would experience a large uplink throughput degradation due to the power limitations of the higher-priority carrier. In accordance with the first implementation, the UE 115-a may monitor the change in the overall uplink throughput contributions of the respective carriers 220 for each TTI (e.g., perform the analysis described above for each TTI). As such, the UE 115-a may be configured to stop pruning communications on one of the carriers 220 if such pruning results in a drop in the uplink throughput (e.g., due to any unforeseen network conditions on the higher-priority carrier 220).

Comparatively, in accordance with a second implementation for evaluating ULCA communications, the UE 115-a may be configured to monitor the impact of higher MPR values while in intra-CC mode (e.g., higher MPR values for ULCA communications), as described previously herein. In accordance with the second implementation, the UE 115-a may evaluate the uplink throughput contribution and the downlink throughput contribution of the lower-priority carrier 220 (e.g., the carrier 220 with the lower uplink throughput contribution). If the uplink throughput degradation of the lower-priority carrier 220 is more than a configured threshold (e.g., uplink throughput contribution is less than an uplink throughput threshold), and if the downlink throughput contribution of the lower-priority carrier 220 is also below a downlink throughput threshold, the UE 115-a may fallback to a single-CC case (e.g., fallback to single-CC communications, as opposed to ULCA communications) by triggering RLF (e.g., vRLF) for the lower-priority carrier 220. As will be described in further detail herein, respective thresholds (e.g., the uplink throughput threshold) may be pre-determined at the UE 115-a, signaled to the UE 115-a from the network, or any combination thereof. Such RLF may be achieved by CQI-0 reporting, by transmitting SRSs on the lower-priority carrier 220 using degraded Tx power, or other known methods.

In some cases, it may be left up to UE-implementation whether the UE 115-a uses the first implementation (e.g., dynamic pruning) or the second implementation (e.g., static evaluation/RLF) for evaluating ULCA communications. Each of the respective implementations will be described in further detail herein.

For example, in the context of the first implementation, and referring to FIG. 2, the UE 115-a may receive control signaling from the network entity 105-a, where the control signaling indicates a power reduction configuration 210 associated with uplink communications (e.g., uplink messages 235) performed by the UE 115-a within aggregated carriers 220. In other words, the control signaling may indicate an MPR configuration for ULCA communications, such as the MPR configuration illustrated in Table 1 above. In this regard, the UE 115-a may be configured to utilize the indicated MPR configuration to determine one or more MPR values that are to be applied when the UE 115-a performs ULCA communications. The control signaling may include RRC signaling, system information signaling, DCI signaling, MAC-CE signaling, and the like.

The UE 115-a may also receive, from the network entity 105-a, a resource allocation 215-a for communicating one or more uplink messages 235 across multiple TTIs 230 within at least a first carrier 220-a (e.g., first CC) and a second carrier 220-b (e.g., second CC). In other words, the UE 115-a may receive a resource allocation 215-a for performing ULCA communications across multiple aggregated carriers 220. For example, as shown in FIG. 2, the resource allocation 215-a may include a first set of resources 225-a within a first carrier 220-a, and a second set of resources 225-b within a second carrier 220-b. In some aspects, the first and second sets of resources 225 may be separated from one another in the frequency domain (e.g., non-contiguous resources across the two carriers 220).

It is noted herein that ULCA communications may be performed across multiple carriers 220, such as two carriers 220, three carriers 220, etc. As such, the discussion of ULCA communications performed within two carriers 220 is provided solely for illustrative purposes, and techniques described herein may be implemented in the context of ULCA communications across more than two carriers 220.

In some cases, the control signaling used to indicate the power reduction configuration 210 (e.g., MPR configuration) and/or the resource allocation 215-a may additionally or alternatively indicate additional information usable by the UE 115-a for evaluating and performing ULCA communications. For example, in some cases, control signaling may indicate a power reduction threshold (MPR_{Thresh}) that the UE 115-a uses to evaluate MPR values for ULCA communications. By way of another example, the control signaling may indicate an uplink throughput threshold (UplinkTP_{Thresh}) that the UE 115-a uses to evaluate uplink throughput contributions associated with the respective carriers 220. The use of the respective thresholds for evaluating ULCA communications will be described in further detail herein.

In some aspects, the UE 115-a may determine power reduction values (e.g., MPR values) associated with the scheduled ULCA communications. In particular, the UE 115-a may determine the power reduction values in accordance with the power reduction configuration 210. For instance, the UE 115-a may reference Table 1 above (or some other table or data object) to determine MPR values that are to be applied to respective RBs of the resource allocation 215-a. In particular, the UE 115-a may determine one or more MPR values that are to be applied for the first carrier 220-a associated with the resource allocation 215-a, and one or more MPR values that are to be applied for the second carrier 220-b associated with the resource allocation 215-a.

In cases where the power reduction value(s) that are to be applied for ULCA communications are sufficiently high (e.g., greater than or equal to some power reduction threshold, which may be configured or signaled to the UE 115-a), the UE 115-a may continue the analysis associated with the first implementation to determine whether or not to dynamically prune communications on the lower-priority carrier 220. That is, if the UE 115-a determines that performing communications in accordance with the ULCA resource allocation 215-a will require high MPR values, the UE 115-a may continue the analysis to determine whether the UE 115-a should fallback to single-CC communications, and/or request a different resource allocation 215-a that will result in lower MPR values.

Conversely, if the MPR values determined for the resource allocation 215-a do not satisfy some power reduction threshold (e.g., relatively low MPR values), the UE 115-a may refrain from performing the remaining steps of the analysis, and may instead transmit uplink messages 235 on both carriers 220-a, 220-b in accordance with the ULCA resource configuration.

Continuing with the description of the first implementation for evaluating ULCA communications, the UE 115-a may determine uplink throughput contribution(s) of the respective carriers 220 (e.g., CCs) associated with the resource allocation 215-a for a first TTI 230-a. Throughput contributions of the respective carriers 220 may be determined as the uplink throughput of the respective carrier 220 divided by the total uplink throughput of the total resource allocation 215-a. The throughput contributions of the respective carriers 220 may be determined based on multiple parameters or factors, including the quantity of resources (RBs) allocated within each carrier 220, the MCS of the resource allocation 215, the average BLER on the respective carriers 220, and the like.

For example, the UE 115-a may determine a first uplink throughput contribution of the first carrier 220-a (UplinkTP_{CC1}) during the first TTI 230-a (e.g., % of uplink throughput attributable to the first carrier 220-a during the first TTI 230-a), and a second uplink throughput contribution of the second carrier 220-b (UplinkTP_{CC2}) during the first TTI 230-a (e.g., % of uplink throughput attributable to the second carrier 220-b during the first TTI 230-a). In some aspects, the carrier 220 with the higher throughput contribution may be designated or referred to as the “high-priority carrier 220,” whereas the carrier 220 with the lower throughput contribution may be designated or referred to as the “low-priority carrier 220.”

The UE 115-a may compare the uplink throughput contribution of the higher-priority carrier 220 for the first TTI 230-a (e.g., the CC with the higher throughput contribution during the first TTI 230-a) to an uplink throughput threshold. For example, the UE 115-a may determine that the first carrier 220-a has the higher throughput contribution (e.g., UplinkTP_{CC1}>UplinkTP_{CC2}, making the first carrier 220-a the higher-priority carrier 220), and may therefore compare the throughput contribution of the first carrier 220-a to the uplink throughput threshold. As noted previously herein, the uplink throughput threshold may be pre-determined at the UE 115-a, signaled to the UE 115-a from the network, or any combination thereof.

If the proportional contribution of the higher-priority carrier 220 does not satisfy the uplink throughput threshold (e.g., UplinkTP_{CC1}<UplinkTP_{Thresh}), then the UE 115-a may determine that performing ULCA communications will not result in significant performance loss, and may therefore perform ULCA communications on both carriers 220 in accordance with the resource allocation 215-a.

Conversely, if the proportional contribution of the higher-priority carrier 220 does satisfy the uplink throughput threshold (UplinkTP_{CC1}≥UplinkTP_{Thresh}) (and assuming the MPR value for the higher-priority carrier 220 is greater than a power reduction threshold), then the UE 115-a may determine that performing ULCA communications will result in significant performance loss, and may therefore perform dynamic pruning on the lower-priority carrier (e.g., second carrier 220-b). In other words, if the higher-priority carrier 220 (e.g., first carrier 220-a) is being significantly power limited due to the power reduction configuration 210 (e.g., MPR configuration) for ULCA communications, and if the higher-priority carrier 220 contributes a substantial proportion of the total uplink throughput, the UE 115-a may prune communications on the lower-priority carrier (e.g., prune the UL DCI of the lower-priority carrier 220 to refrain from performing communications on the lower-priority carrier 220).

As such, if the if the proportional contribution of the higher-priority carrier 220-a does satisfy the uplink throughput threshold (UplinkTP_{CC1}<UplinkTP_{Thresh}) (and assuming the MPR value for the higher-priority CC is greater than a power reduction threshold), the UE 115-a may transmit one or more uplink messages 235-a during the first TTI 230-a within the first carrier 220-a (e.g., higher-priority CC), and may refrain from transmitting within the second carrier 220-b (e.g., lower-priority CC). Stated differently, the UE 115-a may “prune” communications on the lower-priority carrier 220 (e.g., refrain from transmitting on the lower-priority CC).

The UE 115-a may transmit the uplink messages 235-a within the first carrier 220-a (and refrain from transmitting within the second carrier 220-b) based on receiving the power reduction configuration 210, receiving the resource allocation 215-a, determining the MPR value(s), determining the uplink throughput contribution(s) of the carriers 220, comparing the uplink throughput contribution(s) to the uplink throughput threshold, or any combination thereof. In particular, the UE 115-a may transmit the uplink messages 235-a on the first carrier 220-a (e.g., higher-priority CC) and refrain from transmitting on the second carrier 220-b (e.g., lower-priority CC) based on the MPR value of the first carrier 220-a (e.g., based on MPR_{CC1}≥MPR_{Thresh}), and based on the uplink throughput contribution of the first carrier 220-a satisfying the uplink throughput threshold (e.g., based on UplinkTP_{CC1}<UplinkTP_{Thresh}) for the first TTI 230-a.

In some cases, refraining from transmitting within the second carrier 220-b (e.g., pruning the lower-priority CC) may enable the UE 115-a to transmit the uplink messages 235-a within the first TTI 230-a with a lower power reduction value (e.g., lower MPR). This allows UE 115-a to improve overall performance by transmitting on higher priority CC in an uncompromised way with all the available Tx power. In other words, by dropping down from ULCA communications within multiple carriers 220 to transmit the uplink messages 235-a within a single carrier 220, the UE 115-a may be able to transmit the uplink messages 235-a with a higher Tx power (e.g., lower MPR value). Stated differently, the MPR value for single-CC communications, which may be used to transmit the uplink messages 235-a due to the pruning of the lower-priority carrier 220-b, may be less than the MPR value for ULCA communications. As such, by pruning the lower-priority carrier 220-b, the UE 115-a may be able to transmit the uplink messages 235-a within the first TTI 230-a using a higher transmit power than would be possible if the UE 115-a had performed the uplink messages 235-a using the ULCA configuration (e.g., across both carriers 220) and corresponding ULCA-based MPR values.

In accordance with the first implementation for dynamic CC pruning, the UE 115-a may be configured to evaluate whether or not to perform ULCA communications (or prune communications on the lower-priority CC) for each TTI 230 associated with the resource allocation 215-a. Stated differently, in accordance with the first implementation, the UE 115-a may be configured to evaluate, on a per-TTI 230 basis, whether to perform ULCA communications, or whether to prune communications on the lower-priority carrier 220. As such, in accordance with the first implementation, the UE 115-a may be configured to perform the analysis described herein for each respective TTI 230 associated with the resource allocation 215-a.

For example, after pruning communications on the second carrier 220-b for the first TTI 230-a in accordance with the first implementation, the UE 115-a may perform the same analysis for the second TTI 230-b. That is, the UE 115-a may determine uplink throughput contribution(s) of the respective carriers 220-a, 220-b (e.g., CCs) associated with the resource allocation 215-a for the second TTI 230-b.

As described previously herein, the uplink throughput contributions of the respective carriers 220 within the second TTI 230-b may be determined based on multiple parameters or factors, including the quantity of resources (RBs) allocated within each carrier 220, the MCS of the resource allocation 215, the average BLER on the respective carriers 220, and the like. Further, the uplink throughput contribution of the respective CCs may change from TTI 230 to TTI 230 based on other parameters or factors, such as an RV. For example, an RV used to transmit uplink messages 235 may change from the first TTI 230-a to the second TTI 230-b, thereby changing the uplink throughput contributions of the respective carriers 220 from the first TTI 230-a to the second TTI 230-b.

Subsequently, the UE 115-a may compare the uplink throughput contribution of the higher-priority carrier 220 for the second TTI 230-b (e.g., the CC with the higher throughput contribution during the second TTI 230-b) to an uplink throughput threshold. For example, the UE 115-a may determine that the first carrier 220-a has the higher throughput contribution for the second TTI 230-b (e.g., UplinkTP_{CC1}>UplinkTP_{CC2}, making CC1 the higher-priority CC), and may therefore compare the throughput contribution of the first carrier 220-a to an uplink throughput threshold. As noted previously herein, the uplink throughput threshold may be pre-determined at the UE 115-a, signaled to the UE 115-a, or any combination thereof.

Moreover, in some cases, the uplink throughput threshold used to evaluate ULCA communications for the second TTI 230-b may be the same or different as the uplink throughput threshold used to evaluate ULCA communications for the first TTI 230-a. Stated differently, the thresholds used to evaluate ULCA communications (e.g., uplink throughput contribution threshold, MPR threshold, etc.) may be flexible on a per TTI basis, and may be relaxed to bias more towards pruning communications on the lower-priority carrier for first transmission on the higher-priority carrier 220 and non-self-decodable RVs on the lower-priority carrier 220.

For example, the uplink throughput threshold used to evaluate ULCA communications for the first TTI 230-a may be selectively adjusted (e.g., raised, lowered) based on the UE 115-a pruning the lower-priority carrier 220-b in the first TTI 230-a, based on a different RV to be used for communications within the second TTI 230-b, or both. That is, if the UE 115-a has previously pruned communications on a carrier 220, subsequent retransmissions on the same HARQ that have lower expected success (e.g., reduced RV) may also be pruned in a relaxed manner by selectively reducing uplink throughput threshold. For instance, if uplink messages 235 with RV=0 end up getting pruned in the first TTI 230-a, subsequent uplink messages 235 with RV=2 or 3 may also be pruned in subsequent TTIs 230 with relaxed thresholds (e.g., relaxed uplink throughput threshold).

Subsequently, the UE 115-a may transmit one or more additional uplink messages 235-b during the second TTI 230-b within the first carrier 220-a, the second carrier 220-b, or both. In particular, the UE 115-a may determine whether or not to prune communications on the lower-priority carrier 220 during the second TTI 230-b based on determining the uplink throughput contributions of the carriers 220 during the second TTI 230-b, based on comparing the uplink throughput contributions to the same or different (e.g., relaxed) uplink throughout threshold for the second TTI 230-b, or both.

In some aspects, the UE 115-a may transmit a request 240 for the network entity 105-a to adjust the resource allocation 215-a for ULCA communications. In particular, the UE 115-a may transmit the request 240 for the network entity 105-a to adjust the resource allocation 215-a if the UE 115-a has previously pruned communications within some quantity or proportion of previous TTIs 230. That is, the UE 115-a may transmit the request 240 based on pruning communications within a low-priority carrier 220 (e.g., based on pruning communications within the first TTI 230-a, the second TTI 230-b, or both). In some cases, the request 240 may indicate a request 240 for the UE 115-a to fallback to a resource configuration for single-CC communications (as opposed to ULCA communications), a request 240 to allocate more resources to the higher-priority carrier 220, a request 240 to allocate resources within one or more different CCs, or any combination thereof.

For instance, the UE 115-a may utilize signaling for event reporting (e.g., A1, A2, . . . , A5 event reporting) to negatively bias the lower priority carrier 220 in order to influence the network entity 105-a to allocate resources on another carrier 220 when the UL DCI pruning from the first implementation occurs more often than a configured threshold value (e.g., if the UE 115-a prunes a carrier 220 in >30% of TTIs 230). By way of another example, for Class B intra ULCA cases, the UE 115-a may use conditional handover configurations to prioritize a switch to a higher BW carrier 220 (e.g., 100 MHz carrier 220) since the total aggregated BW in ULCA is not more than supported 100 MHz operation for single-CC cases.

In such cases, the UE 115-a may receive a second (e.g., adjusted) resource allocation 215-b from the network entity 105-a. The UE 115-a may receive the second resource allocation 215-b based on transmitting the request 240. In this regard, the second (adjusted) resource allocation 215-b may include a resource allocation 215-b for single-CC communications (e.g., allocate resources only within CC1). Additionally, or alternatively, the second resource allocation 215-b may allocate resources differently within the same carriers 220 as compared to the first resource allocation 215-a, and/or may allocate resources within one or more different carriers 220 as compared to the first resource allocation 215-a. For instance, the second resource allocation 215-b may allocate resources for ULCA communications within the first carrier 220-a (CC1) and a third carrier 220 (CC3, not shown). Subsequently, the devices may communicate with one another in accordance with the second resource allocation 215-b.

In some cases, as described previously herein, the UE 115-a may be configured to autonomously prune communications on the lower-priority carrier 220. Stated differently, in some cases, the network entity 105-a may not know that the UE 115-a will prune communications, and may therefore expect communications on both the respective carriers 220. In additional or alternative implementations, the network entity 105-a may be configured to perform the same or complementary analysis described herein in order to determine whether or not the UE 115-a is expected to prune communications on one of the carriers.

The foregoing description has been described in the context of the first implementation for dynamically pruning carriers 220 for ULCA communications. As described previously herein, in some cases, the UE 115-a may additionally and/or alternatively implement a second implementation for evaluating ULCA communications.

For example, in accordance with the second implementation, and continuing with reference to FIG. 2, the UE 115-a may receive a power reduction configuration 210 for ULCA communications, and a resource allocation 215-a that allocates resources across two (or more) carriers 220 for ULCA communications. As was performed for the first implementation, the UE 115-a may determine power reduction values (e.g., MPR values) associated with the scheduled ULCA communications. In particular, the UE 115-a may determine the power reduction values in accordance with the power reduction configuration 210. For instance, the UE 115-a may reference Table 1 above (or some other table or data object) to determine MPR values that are to be applied to respective RBs of the resource allocation 215-a. In particular, the UE 115-a may determine one or more MPR values that are to be applied for the first carrier 220-a associated with the resource allocation 215-a, and one or more MPR values that are to be applied for the second carrier 220-b associated with the resource allocation 215-a.

Continuing with reference to the second implementation for evaluating ULCA communications, the UE 115-a may determine uplink throughput contribution(s) of the respective carriers 220 (e.g., CCs) associated with the resource allocation 215-a, as described herein. For example, the UE 115-a may determine a first uplink throughput contribution of the first carrier 220-a (UplinkTP_{CC1}), and a second uplink throughput contribution of the second carrier 220-b (UplinkTP_{CC2}). In some aspects, the carrier 220 with the higher throughput contribution may be designated or referred to as the “high-priority carrier 220,” whereas the carrier 220 with the lower throughput contribution may be designated or referred to as the “low-priority carrier 220.”

Further, in accordance with the second implementation, the UE 115-a may determine downlink throughput contribution(s) of the respective carriers 220 (e.g., CCs) associated with the resource allocation 215-a. Downlink throughput contributions of the respective carriers 220 may be determined as the downlink throughput of the respective carrier 220 divided by the total downlink throughput of the total resource allocation 215-a, as described herein. For example, the UE 115-a may determine a first downlink throughput contribution of the first carrier 220-a (DownlinkTP_{CC1}), and a second downlink throughput contribution of the second carrier 220-b (DownlinkTP_{CC2}). In some cases, the UE 115-a may be configured to determine the downlink throughput contribution of the lower-priority carrier 220 (rather than determining the downlink throughput contributions for both/multiple carriers 220).

Subsequently, the UE 115-a may compare the uplink throughput contribution of the higher-priority carrier 220 (e.g., the CC with the higher throughput contribution) to an uplink throughput threshold. For example, the UE 115-a may determine that the first carrier 220-a has the higher throughput contribution (e.g., UplinkTP_{CC1}>UplinkTP_{CC2}, making CC1 the higher-priority CC), and may therefore compare the throughput contribution of the first carrier 220-b to the uplink throughput threshold. As noted previously herein, the uplink throughput threshold may be pre-determined at the UE 115-a, signaled to the UE 115-a, or both.

Similarly, the UE 115-a may compare the downlink throughput contribution of the lower-priority carrier 220 (e.g., the CC with the lower uplink throughput contribution) to a downlink throughput threshold. For example, the UE 115-a may determine that the first carrier 220-a has the higher throughput contribution (e.g., UplinkTP_{CC1}>UplinkTP_{CC2}, making CC1 the higher-priority CC), and may therefore compare the downlink throughput contribution of the second carrier 220-b (e.g., the lower-priority carrier 220) to the downlink throughput threshold. As noted previously herein, the downlink throughput threshold may be pre-determined at the UE 115-a, signaled to the UE 115-a, or both.

If the proportional uplink contribution of the higher-priority carrier 220-a (e.g., CC1) is less than the uplink throughput threshold (e.g., UplinkTP_{CC1}<UplinkTP_{Thresh}), and/or if the proportional downlink contribution of the lower-priority carrier 220-b (e.g., CC2) is greater than the downlink throughput threshold (e.g., DownlinkTP_{CC2}>DownlinkTP_{Thresh}), then the UE 115-a may determine that performing ULCA communications will not result in significant uplink performance loss, and/or may result in significant downlink performance loss. As such, in such cases, the UE 115-a may perform ULCA communications on both carriers 220 in accordance with the resource allocation 215-a.

Conversely, if the proportional contribution of the higher-priority carrier 220-a (e.g., CC1) is greater than the uplink throughput threshold (UplinkTP_{CC1}≥UplinkTP_{Thresh}), and/or if the proportional downlink contribution of the lower-priority carrier 220-b (e.g., CC2) is less than the downlink throughput threshold (e.g., DownlinkTP_{CC2}<DownlinkTP_{Thresh}) (and assuming the MPR value for the higher-priority carrier 220 is greater than a power reduction threshold), then the UE 115-a may determine that performing ULCA communications will result in significant uplink performance loss, and/or will not result in significant downlink performance loss. As such, in such cases, the UE 115-a may therefore “drop” the lower-priority carrier 220 (e.g., trigger RLF to drop the lower-priority CC) to fallback to single-CC communications.

In such cases, in accordance with the second implementation, the UE 115-a may transmit an uplink message to the network entity 105-a, where the uplink message indicates (and/or is configured to trigger) an RLF for the second, lower-priority carrier 220 (e.g., second carrier 220-b, CC2). For example, the UE 115-a may trigger RLF for the lower-priority carrier (and therefore fallback to single-CC communications) if the proportional uplink contribution of the higher-priority CC is greater than the uplink throughput threshold (UplinkTP_{CC1}≥UplinkTP_{Thresh}), and/or if the proportional downlink contribution of the lower-priority CC is less than the downlink throughput threshold (e.g., DownlinkTP_{CC2}<DownlinkTP_{Thresh}).

The UE 115-a may trigger RLF for the lower-priority carrier 220-b by a variety of means, such as through CQI-0 reporting, by transmitting an uplink message with a request to drop the lower-priority carrier 220-b, and the like. For example, in some cases, the UE 115-a may transmit SRSs with degraded transmissions (e.g., reduced Tx power) on the lower-priority CC(s) to influence network to trigger RLF for the lower-priority CC, and/or to influence the network to allocate more resources for the higher-priority CC (or another CC). For example, a SRS may be transmitted with degraded transmission power on non-preferred RBs to influence the network to allocate resources to the UE 115-a on preferred RBs, which may reduce the amount of transmit power back off. As compared to the first implementation, where the UE 115-a evaluates whether to prune communications for each respective TTI 230, the UE 115-a may be configured to trigger RLF for the lower-priority carrier 220 for all TTIs 230 associated with the resource allocation 215-a.

Subsequently, the UE 115-a may transmit one or more uplink messages 235 to the network entity 105-a. In particular, the UE 115-a may transmit the one or more uplink messages 235 within resources allocated within the first carrier 220-a in accordance with the resource allocation 215-a, and based on triggering RLF for the second carrier 220-b. In some cases, triggering RLF for the second carrier 220-b and falling back to single-CC communications may enable the UE 115-a to transmit the uplink messages 235 within the first carrier 220-a with a lower power reduction value, as described previously herein. In other words, by dropping down from ULCA communications within multiple CCs to transmit the uplink messages 235 within a single CC, the UE 115-a may be able to transmit the messages with a higher Tx power (e.g., lower MPR value). Stated differently, the MPR value for single-CC communications, which may be used at 445 due to the pruning of the lower-priority CC, may be less than the MPR value for ULCA communications determined at 415.

Techniques descried herein may enable more efficient and effective ULCA communications. In particular, techniques described herein may enable the UE 115-a to perform ULCA communications when such ULCA communications result in increased throughput and/or uplink data capacity, but to drop back down to single-carrier 220 communications (and/or modified ULCA configurations) when such ULCA communications require high MPR values that restrict network coverage or uplink throughput/capacity. As such, aspects of the present disclosure enable more dynamic ULCA communications where wireless devices are able to evaluate whether or not such ULCA communications will result in increased throughput or performance.

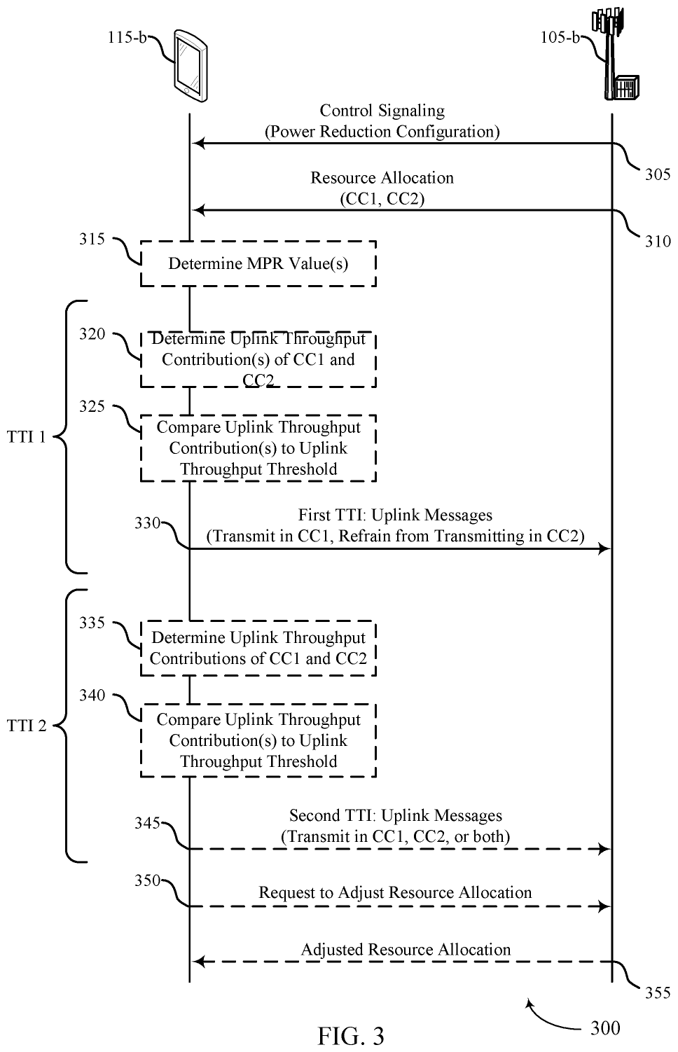

FIG. 3 shows an example of a process flow 300 that supports techniques for ULCA communications in accordance with one or more aspects of the present disclosure. Aspects of the process flow 300 may implement, or be implemented by, aspects of the wireless communications system 100, the wireless communications system 200, or both. For example, the process flow 300 illustrates signaling and configurations that enable dynamic ULCA communications configurations, as described previously herein.

The process flow 300 includes a UE 115-b and a network entity 105-b, which may be examples of UEs 115, network entities 105, and other wireless devices as described herein. For example, the UE 115-b and the network entity 105-b illustrated in FIG. 3 may include examples of the UE 115-a and the network entity 105-a, respectively, as illustrated in FIG. 2.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 305, the UE 115-b may receive control signaling from the network entity 105-b, where the control signaling indicates a power reduction configuration associated with uplink communications performed by the UE 115-b within aggregated carriers. In other words, the control signaling may indicate an MPR configuration for ULCA communications, such as the MPR configuration illustrated in Table 1 above. In this regard, the UE 115-b may be configured to utilize the indicated MPR configuration to determine one or more MPR values that are to be applied when the UE 115-b performs ULCA communications. The control signaling may include RRC signaling, system information signaling, DCI signaling, MAC-CE signaling, and the like.

At 310, the UE 115-b may receive, from the network entity 105-b, a resource allocation for communicating one or more uplink messages across multiple TTIs within at least a first carrier (e.g., first CC) and a second carrier (e.g., second CC). In other words, the UE 115-b may receive a resource configuration for performing ULCA communications across multiple aggregated CCs. For example, as shown in FIG. 2, the resource allocation may include a first set of resources within a first CC, and a second set of resources within a second CC. In some aspects, the first and second sets of resources may be separated from one another in the frequency domain (e.g., non-contiguous resources across the two CCs).

The UE 115-b may receive the resource allocation at 310 based on receiving the control signaling at 305. Further, the resource allocation at 310 may be received via the same or different signaling as compared to the control signaling at 305. For example, in some cases, MPR configuration and the resource allocation may be signaled/configured via the same control messages.

In some cases, the control signaling used to indicate the power reduction configuration (e.g., MPR configuration) and/or the resource allocation may additionally or alternatively indicate additional information usable by the UE 115-b for evaluating and performing ULCA communications. For example, in some cases, the control signaling at 305, 310, or both, may indicate a power reduction threshold (MPR_{Thresh}) that the UE 115-b uses to evaluate MPR values for ULCA communications. By way of another example, the control signaling at 305, 310, or both, may indicate an uplink throughput threshold (UplinkTP_{Thresh}) that the UE 115-b uses to evaluate uplink throughput contributions associated with the respective carriers. The use of the respective thresholds for evaluating ULCA communications will be described in further detail herein.

At 315, the UE 115-b may determine power reduction values (e.g., MPR values) associated with the scheduled ULCA communications. In particular, the UE 115-b may determine the power reduction values in accordance with the power reduction configuration indicated at 305. For instance, the UE 115-b may reference Table 1 above (or some other table or data object) to determine MPR values that are to be applied to respective RBs of the resource allocation. In particular, the UE 115-b may determine one or more MPR values that are to be applied for the first carrier associated with the resource allocation, and one or more MPR values that are to be applied for the second carrier associated with the resource allocation.

In cases where the power reduction value(s) that are to be applied for ULCA communications are sufficiently high (e.g., greater than or equal to some power reduction threshold, which may be configured via the control signaling at 305), the process flow 300 may proceed to step 320. That is, if the UE 115-b determines that performing communications in accordance with the ULCA resource configuration will require high MPR values, the UE 115-b may continue the analysis shown and described in FIG. 3 to determine whether the UE 115-b should fallback to single-CC communications, and/or request a different resource configuration that will result in lower MPR values. Conversely, if the MPR values determined at 315 do not satisfy some power reduction threshold (e.g., relatively low MPR values), the UE 115-b may refrain from performing the remaining steps of the process flow 300, and may instead transmit uplink messages on both carriers in accordance with the ULCA resource configuration.

At 320, the UE 115-b may determine uplink throughput contribution(s) of the respective carriers (e.g., CCs) associated with the resource allocation for a first TTI (TTI 1). Throughput contributions of the respective carriers may be determined as the uplink throughput of the respective carrier divided by the total uplink throughput of the total resource allocation. The throughput contributions of the respective carriers may be determined based on multiple parameters or factors, including the quantity of resources (RBs) allocated within each carrier, the MCS of the resource allocation, the average BLER on the respective carriers, and the like.

For example, the UE 115-b may determine a first uplink throughput contribution of the first CC (UplinkTP_{CC1}) during the first TTI (e.g., % of uplink throughput attributable to the first CC during the first TTI), and a second uplink throughput contribution of the second CC (UplinkTP_{CC2}) during the first TTI (e.g., % of uplink throughput attributable to the second CC during the first TTI). In some aspects, the carrier with the higher throughput contribution may be designated or referred to as the “high-priority carrier,” whereas the carrier with the lower throughput contribution may be designated or referred to as the “low-priority carrier.”

At 325, the UE 115-b may compare the uplink throughput contribution of the higher-priority carrier for the first TTI (e.g., the CC with the higher throughput contribution during the first TTI) to an uplink throughput threshold. For example, the UE 115-b may determine that CC1 has the higher throughput contribution (e.g., UplinkTP_{CC1}>UplinkTP_{CC2}, making CC1 the higher-priority CC), and may therefore compare the throughput contribution of CC1 to the uplink throughput threshold. As noted previously herein, the uplink throughput threshold may be pre-determined at the UE 115-b, signaled via the control signaling at 305 and/or 310, or any combination thereof.

If the proportional contribution of the higher-priority CC does not satisfy the uplink throughput threshold (e.g., UplinkTP_{CC1}<UplinkTP_{Thresh}), then the UE 115-b may determine that performing ULCA communications will not result in significant performance loss, and may therefore perform ULCA communications on both CCs in accordance with the resource configuration.

Conversely, if the proportional contribution of the higher-priority CC does satisfy the uplink throughput threshold (UplinkTP_{CC1}≥UplinkTP_{Thresh}) (and assuming the MPR value for the higher-priority CC is greater than a power reduction threshold), then the UE 115-b may determine that performing ULCA communications will result in significant performance loss, and may therefore perform dynamic pruning on the lower-priority CC (e.g., CC2). In other words, if the higher-priority carrier is being significantly power limited due to the MPR configuration for ULCA communications, and if the higher-priority carrier contributes a substantial proportion of the total uplink throughput, the UE 115-b may prune communications on the lower-priority CC (e.g., prune the UL DCI of the lower-priority carrier to refrain from performing communications on the lower-priority carrier).

As such, if the if the proportional contribution of the higher-priority CC does satisfy the uplink throughput threshold (UplinkTP_{CC1}<UplinkTP_{Thresh}) (and assuming the MPR value for the higher-priority CC is greater than a power reduction threshold), the process flow 300 may proceed to step 330.

At 330, the UE 115-b may transmit one or more uplink messages during the first TTI within the first carrier, and may refrain from transmitting within the second carrier. Stated differently, the UE 115-b may “prune” communications on the lower-priority CC (e.g., refrain from transmitting on the lower-priority CC).

The UE 115-b may transmit the uplink messages within the first carrier (and refrain from transmitting within the second carrier) at 330 based on receiving the control signaling at 305, receiving the resource allocation at 310, determining the MPR value(s) at 315, determining the uplink throughput contribution(s) at 320, comparing the uplink throughput contribution(s) to the uplink throughput threshold at 325, or any combination thereof. In particular, the UE 115-b may transmit the uplink messages on the first CC (e.g., higher-priority CC) and refrain from transmitting on the second CC (e.g., lower-priority CC) based on the MPR value of the first CC (e.g., based on MPR_{CC1}≥MPR_{Thresh}), and based on the uplink throughput contribution of the first CC satisfying the uplink throughput threshold (e.g., based on UplinkTP_{CC1}<UplinkTP_{Thresh}) for the first TTI.

In some cases, refraining from transmitting within the second carrier (e.g., pruning the lower-priority CC) may enable the UE 115-b to transmit the uplink messages within the first TTI at 325 with a lower power reduction value. In other words, by dropping down from ULCA communications within multiple CCs to transmit the uplink messages within a single CC, the UE 115-b may be able to transmit the messages with a higher Tx power (e.g., lower MPR value). Stated differently, the MPR value for single-CC communications, which may be used at 330 due to the pruning of the lower-priority CC, may be less than the MPR value for ULCA communications. As such, by pruning the lower-priority CC at 330, the UE 115-b may be able to transmit the uplink messages at 330 using a higher transmit power than would be possible if the UE 115-b had performed the uplink messages using the ULCA configuration and corresponding ULCA-based MPR values.

In accordance with the first implementation for dynamic CC pruning, the UE 115-b may be configured to evaluate whether or not to perform ULCA communications (or prune communications on the lower-priority CC) for each TTI associated with the resource allocation. Stated differently, in accordance with the first implementation, the UE 115-b may be configured to evaluate, on a per-TTI basis, whether to perform ULCA communications, or whether to prune communications on the lower-priority CC. As such, in accordance with the first implementation, the UE 115-b may be configured to perform at least steps 320 and 325 for each respective TTI associated with the resource allocation.

At 335, the UE 115-b may determine uplink throughput contribution(s) of the respective carriers (e.g., CCs) associated with the resource allocation for a second TTI (TTI 2). Any description associated with step 320 may be regarded as applying to step 335, to the extent applicable.

As described previously herein, the throughput contributions of the respective carriers may be determined based on multiple parameters or factors, including the quantity of resources (RBs) allocated within each carrier, the MCS of the resource allocation, the average BLER on the respective carriers, and the like. Further, the uplink throughput contribution of the respective CCs may change from TTI to TTI based on other parameters or factors, such as an RV. For example, an RV used to transmit uplink messages may change from TTI1 to TTI2, thereby changing the uplink throughput contributions of the respective CCs from TTI1 to TTI2.

At 340, the UE 115-b may compare the uplink throughput contribution of the higher-priority carrier for the second TTI (e.g., the CC with the higher throughput contribution during the second TTI) to an uplink throughput threshold. Any description associated with step 325 may be regarded as applying to step 340, to the extent applicable.

For example, the UE 115-b may determine that CC1 has the higher throughput contribution for the second TTI (e.g., UplinkTP_{CC1}>UplinkTP_{CC2}, making CC1 the higher-priority CC), and may therefore compare the throughput contribution of CC1 to an uplink throughput threshold. As noted previously herein, the uplink throughput threshold may be pre-determined at the UE 115-b, signaled via the control signaling at 305 and/or 310, or any combination thereof.

Moreover, in some cases, the uplink throughput threshold used at 340 may be the same or different as the uplink throughput threshold used at 325. For example, the uplink throughput threshold used at 325 may be selectively adjusted (e.g., raised, lowered) based on the UE 115-b pruning the lower-priority carrier at 330, based on a different RV to be used for communications within the second TTI, or both. That is, if the UE 115-b has previously pruned communications on a carrier, subsequent retransmissions on the same HARQ that have lower expected success (e.g., reduced RV) may also be pruned in a relaxed manner by selectively reducing uplink throughput threshold. For instance, if uplink messages with RV=0 end up getting pruned in the first TTI at 330, subsequent uplink messages with RV=2 or 3 may also be pruned in subsequent TTIs with relaxed thresholds (e.g., relaxed uplink throughput threshold).

At 345, the UE 115-b may transmit one or more additional uplink messages during the second TTI within the first carrier, the second carrier, or both. In particular, the UE 115-b may determine whether or not to prune communications on the lower-priority carrier during the second TTI based on determining the uplink throughput contributions of the CCs during the second TTI at 335, based on comparing the uplink throughput contributions to the same or different (e.g., relaxed) uplink throughout threshold at 340, or both. In this regard, any discussion associated with step 330 may be regarded as applying to step 345, to the extent applicable.

At 350, the UE 115-b may transmit a request for the network entity 105-b to adjust the resource allocation for ULCA communications. In particular, the UE 115-b may request that the network entity 105-b adjusts the resource allocation if the UE 115-b has previously pruned communications within some quantity or proportion of previous TTIs. That is, the UE 115-b may transmit the request at 350 based on pruning communications within a low-priority carrier at 330, 345, or both. In some cases, the request may indicate a request for the UE 115-b to fallback to a resource configuration for single-CC communications (as opposed to ULCA communications), a request to allocate more resources to the higher-priority CC, a request to allocate resources within one or more different CCs, or any combination thereof.

At 350, the UE 115-b may receive a second (e.g., adjusted) resource allocation from the network entity 105-b. The UE 115-b may receive the second resource allocation at 355 based on transmitting the request at 350. In this regard, the second (adjusted) resource allocation may include a resource allocation for single-CC communications (e.g., allocate resources only within CC1). Additionally, or alternatively, the second resource allocation may allocate resources differently within the same CCs as compared to the first resource allocation, and/or may allocate resources within one or more different CCs as compared to the first resource allocation. For instance, the second resource allocation may allocate resources for ULCA communications within the first carrier (CC1) and a third carrier (CC3). Subsequently, the devices may communicate with one another in accordance with the second resource configuration.

Techniques descried herein may enable more efficient and effective ULCA communications. In particular, techniques described herein may enable the UE 115-b to perform ULCA communications when such ULCA communications result in increased throughput and/or uplink data capacity, but to drop back down to single-carrier communications (and/or modified ULCA configurations) when such ULCA communications require high MPR values that restrict network coverage or uplink throughput/capacity. As such, aspects of the present disclosure enable more dynamic ULCA communications where wireless devices are able to evaluate whether or not such ULCA communications will result in increased throughput or performance.

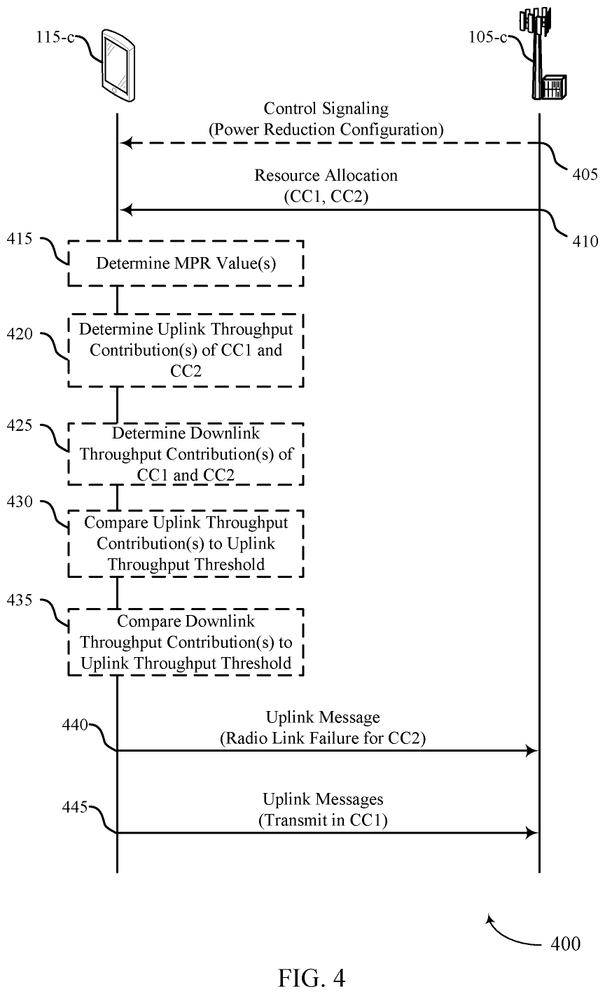

FIG. 4 shows an example of a process flow 400 that supports techniques for ULCA communications in accordance with one or more aspects of the present disclosure. Aspects of the process flow 400 may implement, or be implemented by, aspects of the wireless communications system 100, the wireless communications system 200, the process flow 300, or any combination thereof. For example, the process flow 400 illustrates signaling and configurations that enable dynamic ULCA communications configurations, as described previously herein.

The process flow 400 includes a UE 115-c and a network entity 105-c, which may be examples of UEs 115, network entities 105, and other wireless devices as described herein. For example, the UE 115-c and the network entity 105-c illustrated in FIG. 4 may include examples of the UE 115-a and the network entity 105-a, respectively, as illustrated in FIG. 2.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the UE 115-c may receive control signaling from the network entity 105-c, where the control signaling indicates a power reduction configuration associated with uplink communications performed by the UE 115-c within aggregated carriers. In other words, the control signaling may indicate an MPR configuration for ULCA communications, such as the MPR configuration illustrated in Table 1 above. In this regard, the UE 115-c may be configured to utilize the indicated MPR configuration to determine one or more MPR values that are to be applied when the UE 115-c performs ULCA communications. The control signaling may include RRC signaling, system information signaling, DCI signaling, MAC-CE signaling, and the like.

At 410, the UE 115-c may receive, from the network entity 105-c, a resource allocation for communicating one or more uplink messages across multiple TTIs within at least a first carrier (e.g., first CC) and a second carrier (e.g., second CC). In other words, the UE 115-c may receive a resource configuration for performing ULCA communications across multiple aggregated CCs. For example, as shown in FIG. 2, the resource allocation may include a first set of resources within a first CC, and a second set of resources within a second CC. In some aspects, the first and second sets of resources may be separated from one another in the frequency domain (e.g., non-contiguous resources across the two CCs).

The UE 115-c may receive the resource allocation at 410 based on receiving the control signaling at 405. Further, the resource allocation at 410 may be received via the same or different signaling as compared to the control signaling at 405. For example, in some cases, MPR configuration and the resource allocation may be signaled/configured via the same control messages.

In some cases, the control signaling used to indicate the power reduction configuration (e.g., MPR configuration) and/or the resource allocation may additionally or alternatively indicate additional information usable by the UE 115-c for evaluating and performing ULCA communications. For example, in some cases, the control signaling at 405, 410, or both, may indicate a power reduction threshold (MPR_{Thresh}) that the UE 115-c uses to evaluate MPR values for ULCA communications. By way of another example, the control signaling at 405, 410, or both, may indicate an uplink throughput threshold (UplinkTP_{Thresh}) and/or downlink throughput threshold (DownlinkTP_{Thresh}) that the UE 115-c uses to evaluate uplink/downlink throughput contributions associated with the respective carriers. The use of the respective thresholds for evaluating ULCA communications will be described in further detail herein.

At 415, the UE 115-c may determine power reduction values (e.g., MPR values) associated with the scheduled ULCA communications. In particular, the UE 115-c may determine the power reduction values in accordance with the power reduction configuration indicated at 405. For instance, the UE 115-c may reference Table 1 above (or some other table or data object) to determine MPR values that are to be applied to respective RBs of the resource allocation. In particular, the UE 115-c may determine one or more MPR values that are to be applied for the first carrier associated with the resource allocation, and one or more MPR values that are to be applied for the second carrier associated with the resource allocation.

In cases where the power reduction value(s) that are to be applied for ULCA communications are sufficiently high (e.g., greater than or equal to some power reduction threshold, which may be configured via the control signaling at 405), the process flow 400 may proceed to step 420. That is, if the UE 115-c determines that performing communications in accordance with the ULCA resource configuration will require high MPR values, the UE 115-c may continue the analysis shown and described in FIG. 4 to determine whether the UE 115-c should fallback to single-CC communications. Conversely, if the MPR values determined at 415 do not satisfy some power reduction threshold (e.g., relatively low MPR values), the UE 115-c may refrain from performing the remaining steps of the process flow 300, and may instead transmit uplink messages on both carriers in accordance with the ULCA resource configuration.

At 420, the UE 115-c may determine uplink throughput contribution(s) of the respective carriers (e.g., CCs) associated with the resource allocation. Throughput contributions of the respective carriers may be determined as the uplink throughput of the respective carrier divided by the total uplink throughput of the total resource allocation. The throughput contributions of the respective carriers may be determined based on multiple parameters or factors, including the quantity of resources (RBs) allocated within each carrier, the MCS of the resource allocation, the average BLER on the respective carriers, and the like.

For example, the UE 115-c may determine a first uplink throughput contribution of the first CC (UplinkTP_{CC1}), and a second uplink throughput contribution of the second CC (UplinkTP_{CC2}). In some aspects, the carrier with the higher throughput contribution may be designated or referred to as the “high-priority carrier,” whereas the carrier with the lower throughput contribution may be designated or referred to as the “low-priority carrier.”

At 425, the UE 115-c may determine downlink throughput contribution(s) of the respective carriers (e.g., CCs) associated with the resource allocation. Throughput contributions of the respective carriers may be determined as the downlink throughput of the respective carrier divided by the total downlink throughput of the total resource allocation. The throughput contributions of the respective carriers may be determined based on multiple parameters or factors, including the quantity of resources (RBs) allocated within each carrier, the MCS of the resource allocation, the average BLER on the respective carriers, and the like.

For example, the UE 115-c may determine a first downlink throughput contribution of the first CC (DownlinkTP_{CC1}), and a second downlink throughput contribution of the second CC (DownlinkTP_{CC2}). In some cases, the UE 115-c may be configured to determine the downlink throughput contribution of the lower-priority carrier (rather than determining the downlink throughput contributions for both/multiple carriers).

At 430, the UE 115-c may compare the uplink throughput contribution of the higher-priority carrier (e.g., the CC with the higher throughput contribution) to an uplink throughput threshold. For example, the UE 115-c may determine that CC1 has the higher throughput contribution (e.g., UplinkTP_{CC1}>UplinkTP_{CC2}, making CC1 the higher-priority CC), and may therefore compare the throughput contribution of CC1 to the uplink throughput threshold. As noted previously herein, the uplink throughput threshold may be pre-determined at the UE 115-c, signaled via the control signaling at 405 and/or 410, or any combination thereof.

At 435, the UE 115-c may compare the downlink throughput contribution of the lower-priority carrier (e.g., the CC with the lower uplink throughput contribution) to a downlink throughput threshold. For example, the UE 115-c may determine that CC1 has the higher throughput contribution (e.g., UplinkTP_{CC1}>UplinkTP_{CC2}, making CC1 the higher-priority CC), and may therefore compare the downlink throughput contribution of CC2 (e.g., the lower-priority CC) to the downlink throughput threshold. As noted previously herein, the downlink throughput threshold may be pre-determined at the UE 115-c, signaled via the control signaling at 405 and/or 410, or any combination thereof.

If the proportional uplink contribution of the higher-priority CC is less than the uplink throughput threshold (e.g., UplinkTP_{CC1}<UplinkTP_{Thresh}), and/or if the proportional downlink contribution of the lower-priority CC is greater than the downlink throughput threshold (e.g., DownlinkTP_{CC2}>DownlinkTP_{Thresh}), then the UE 115-c may determine that performing ULCA communications will not result in significant uplink performance loss, and/or may result in significant downlink performance loss. As such, in such cases, the UE 115-c may perform ULCA communications on both CCs in accordance with the resource allocation.

Conversely, if the proportional contribution of the higher-priority CC is greater than the uplink throughput threshold (UplinkTP_{CC1}≥UplinkTP_{Thresh}), and/or if the proportional downlink contribution of the lower-priority CC is less than the downlink throughput threshold (e.g., DownlinkTP_{CC2}<DownlinkTP_{Thresh}) (and assuming the MPR value for the higher-priority CC is greater than a power reduction threshold), then the UE 115-c may determine that performing ULCA communications will result in significant uplink performance loss, and/or will not result in significant downlink performance loss. As such, in such cases, the UE 115-c may therefore “drop” the lower-priority CC (e.g., trigger RLF to drop the lower-priority CC) to fallback to single-CC communications.

At 440, the UE 115-c may transmit an uplink message to the network entity 105-c, where the uplink message indicates (and/or is configured to trigger) an RLF for the second, lower-priority carrier. The UE 115-c may transmit the uplink message indicating/triggering RLF of the second CC at 440 based on receiving the control signaling at 405, receiving the resource allocation at 410, determining the MPR value(s) at 415, determining the uplink throughput contribution(s) at 420, determining the downlink throughput contribution(s) at 425, comparing the uplink throughput contribution(s) to the uplink throughput threshold at 430, comparing the downlink throughput contribution(s) to the downlink throughput threshold at 435, or any combination thereof.

For example, the UE 115-c may trigger RLF for the lower-priority CC (and therefore fallback to single-CC communications) if the proportional uplink contribution of the higher-priority CC is greater than the uplink throughput threshold (UplinkTP_{CC1}≥UplinkTP_{Thresh}), and/or if the proportional downlink contribution of the lower-priority CC is less than the downlink throughput threshold (e.g., DownlinkTP_{CC2}<DownlinkTP_{Thresh}).

The UE 115-c may trigger RLF for the lower-priority CC by a variety of means, such as through CQI-0 reporting, by transmitting an uplink message with a request to drop the lower-priority CC, and the like. For example, in some cases, the UE 115-c may transmit SRSs with degraded transmissions (e.g., reduced Tx power) on the lower-priority CC(s) to influence network to trigger RLF for the lower-priority CC, and/or to influence the network to allocate more resources for the higher-priority CC (or another CC).

At 445, the UE 115-c may transmit one or more uplink messages to the network entity 105-c. In particular, the UE 115-c may transmit the one or more messages within resources allocated within the first carrier in accordance with the resource allocation, and based on triggering RLF for the second carrier. In this regard, the UE 115-c may transmit the uplink messages at 445 based on receiving the control signaling at 405, receiving the resource allocation at 410, determining the MPR value(s) at 415, determining the uplink throughput contribution(s) at 420, determining the downlink throughput contribution(s) at 425, comparing the uplink throughput contribution(s) to the uplink throughput threshold at 430, comparing the downlink throughput contribution(s) to the downlink throughput threshold at 435, indicating/triggering RLF for the lower-priority CC at 440, or any combination thereof.

In some cases, triggering RLF for the second carrier and falling back to single-CC communications may enable the UE 115-c to transmit the uplink messages within the first carrier at 445 with a lower power reduction value. In other words, by dropping down from ULCA communications within multiple CCs to transmit the uplink messages within a single CC, the UE 115-c may be able to transmit the messages with a higher Tx power (e.g., lower MPR value). Stated differently, the MPR value for single-CC communications, which may be used at 445 due to the pruning of the lower-priority CC, may be less than the MPR value for ULCA communications determined at 415.

Techniques descried herein may enable more efficient and effective ULCA communications. In particular, techniques described herein may enable the UE 115-c to perform ULCA communications when such ULCA communications result in increased throughput and/or uplink data capacity, but to drop back down to single-carrier communications (and/or modified ULCA configurations) when such ULCA communications require high MPR values that restrict network coverage or uplink throughput/capacity. As such, aspects of the present disclosure enable more dynamic ULCA communications where wireless devices are able to evaluate whether or not such ULCA communications will result in increased throughput or performance.

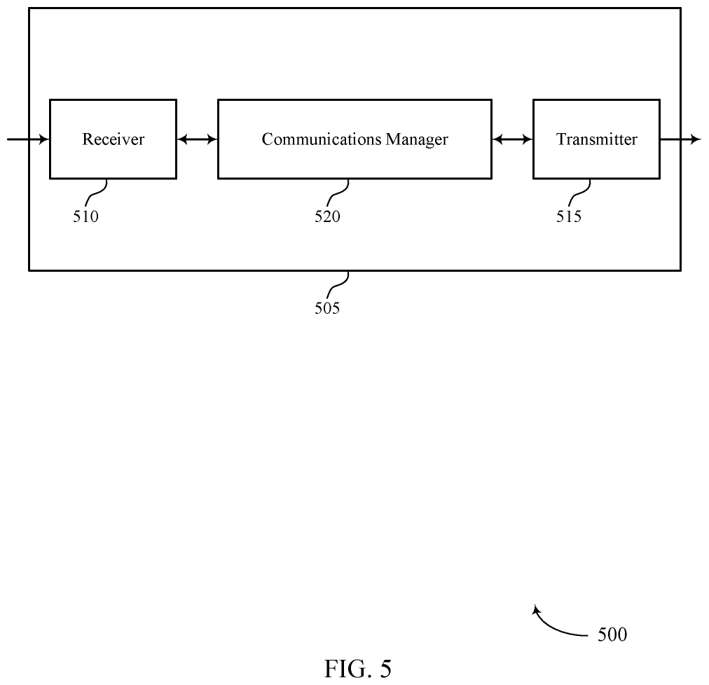

FIG. 5 shows a diagram 500 of a device 505 that supports techniques for ULCA communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for ULCA communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for ULCA communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for ULCA communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a network entity, control signaling indicating a power reduction configuration associated with uplink communications performed by the UE within aggregated carriers. The communications manager 520 is capable of, configured to, or operable to support a means for receiving, via the control signaling, additional control signaling, or both, a resource allocation for communicating one or more uplink messages across a set of multiple TTIs within a first carrier and a second carrier, where the resource allocation includes a first set of resources within the first carrier and a second set of resources within the second carrier. The communications manager 520 is capable of, configured to, or operable to support a means for transmitting, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI.

Additionally, or alternatively, the communications manager 520 may support wireless communications in accordance with examples as disclosed herein. For example, the communications manager 520 is capable of, configured to, or operable to support a means for receiving, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources. The communications manager 520 is capable of, configured to, or operable to support a means for transmitting, to the network entity, an uplink message indicating an RLF associated with the second carrier based on the second throughput contribution of the second carrier failing to satisfy an uplink throughput threshold, and based on a downlink contribution of the second carrier failing to satisfy a downlink throughput threshold. The communications manager 520 is capable of, configured to, or operable to support a means for transmitting the one or more uplink messages within the first set of resources of the first carrier based on the resource allocation and the uplink message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques that enable more efficient and effective ULCA communications. In particular, techniques described herein may enable UEs 115 to perform ULCA communications when such ULCA communications result in increased throughput and/or uplink data capacity, but to drop back down to single-carrier communications (and/or modified ULCA configurations) when such ULCA communications require high MPR values that restrict network coverage or uplink throughput/capacity. As such, aspects of the present disclosure enable more dynamic ULCA communications where wireless devices are able to evaluate whether or not such ULCA communications will result in increased throughput or performance.

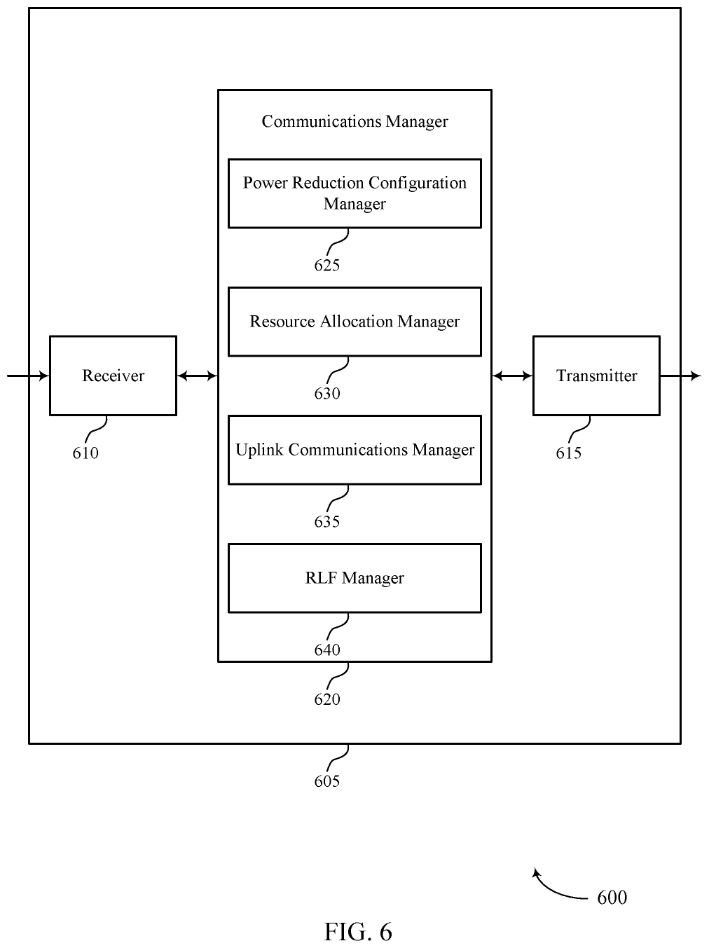

FIG. 6 shows a diagram 600 of a device 605 that supports techniques for ULCA communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for ULCA communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for ULCA communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for ULCA communications as described herein. For example, the communications manager 620 may include a power reduction configuration manager 625, a resource allocation manager 630, an uplink communications manager 635, an RLF manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The power reduction configuration manager 625 is capable of, configured to, or operable to support a means for receiving, from a network entity, control signaling indicating a power reduction configuration associated with uplink communications performed by the UE within aggregated carriers. The resource allocation manager 630 is capable of, configured to, or operable to support a means for receiving, via the control signaling, additional control signaling, or both, a resource allocation for communicating one or more uplink messages across a set of multiple TTIs within a first carrier and a second carrier, where the resource allocation includes a first set of resources within the first carrier and a second set of resources within the second carrier. The uplink communications manager 635 is capable of, configured to, or operable to support a means for transmitting, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI.

Additionally, or alternatively, the communications manager 620 may support wireless communications in accordance with examples as disclosed herein. The resource allocation manager 630 is capable of, configured to, or operable to support a means for receiving, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources. The RLF manager 640 is capable of, configured to, or operable to support a means for transmitting, to the network entity, an uplink message indicating an RLF associated with the second carrier based on the second throughput contribution of the second carrier failing to satisfy an uplink throughput threshold, and based on a downlink contribution of the second carrier failing to satisfy a downlink throughput threshold. The uplink communications manager 635 is capable of, configured to, or operable to support a means for transmitting the one or more uplink messages within the first set of resources of the first carrier based on the resource allocation and the uplink message.

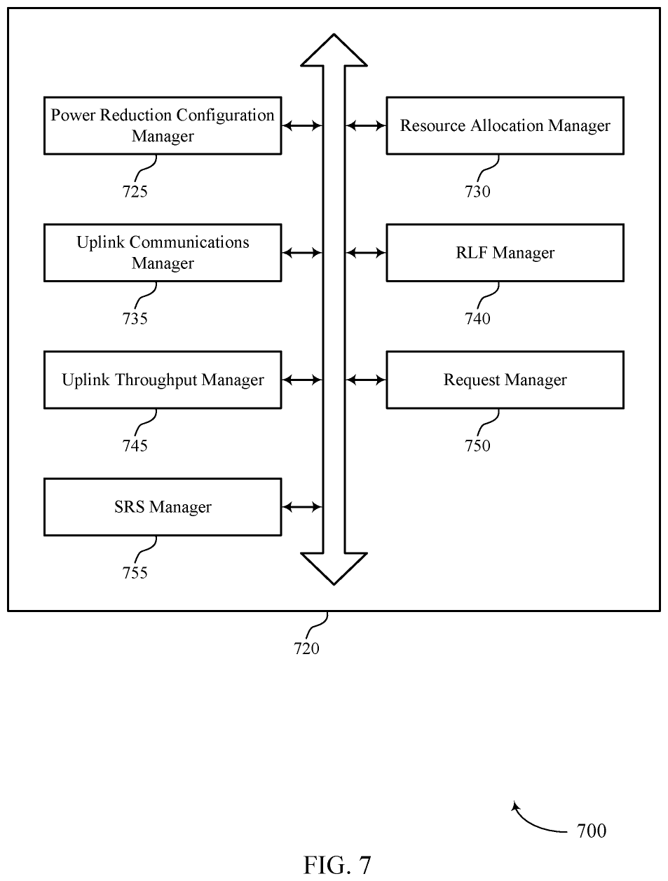

FIG. 7 shows a diagram 700 of a communications manager 720 that supports techniques for ULCA communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for ULCA communications as described herein. For example, the communications manager 720 may include a power reduction configuration manager 725, a resource allocation manager 730, an uplink communications manager 735, an RLF manager 740, an uplink throughput manager 745, a request manager 750, an SRS manager 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The power reduction configuration manager 725 is capable of, configured to, or operable to support a means for receiving, from a network entity, control signaling indicating a power reduction configuration associated with uplink communications performed by the UE within aggregated carriers. The resource allocation manager 730 is capable of, configured to, or operable to support a means for receiving, via the control signaling, additional control signaling, or both, a resource allocation for communicating one or more uplink messages across a set of multiple TTIs within a first carrier and a second carrier, where the resource allocation includes a first set of resources within the first carrier and a second set of resources within the second carrier. The uplink communications manager 735 is capable of, configured to, or operable to support a means for transmitting, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI.

In some examples, the uplink communications manager 735 is capable of, configured to, or operable to support a means for transmitting the one or more uplink messages within the first carrier in accordance with a second power reduction value that is different from the power reduction value based on refraining from transmitting within the second set of resources.

In some examples, the second power reduction value is associated with a higher Tx power as compared to the power reduction value.

In some examples, transmitting the one or more uplink messages within the first set of resources, and refraining from transmitting within the second set of resources, is based on the power reduction value of the first carrier being greater than or equal to a power reduction threshold.

In some examples, transmitting the one or more uplink messages within the first set of resources, and refraining from transmitting within the second set of resources, is based on the first throughput contribution associated with the first carrier being greater than a second throughput contribution associated with the second carrier during the first TTI of the set of multiple TTIs.

In some examples, the first throughput contribution and the second throughput contribution are based on quantities of resource blocks included within the first set of resources and the second set of resources, respectively, an MCS associated with the first carrier or the second carrier, a BLER associated with the first carrier or the second carrier, or any combination thereof.

In some examples, the power reduction configuration manager 725 is capable of, configured to, or operable to support a means for receiving, via the control signaling, the additional control signaling, or both, an indication of the power reduction threshold.

In some examples, the uplink throughput manager 745 is capable of, configured to, or operable to support a means for receiving, via the control signaling, the additional control signaling, or both, an indication of the uplink throughput threshold.

In some examples, the uplink communications manager 735 is capable of, configured to, or operable to support a means for transmitting, during a second TTI of the set of multiple TTIs, one or more additional uplink messages within the first set of resources of the first carrier and the second set of resources of the second carrier based on a second throughput contribution of the first set of resources failing to satisfy the uplink throughput threshold, an additional uplink throughput threshold, or both, for the second TTI, based on a power reduction value of the first carrier failing to satisfy a power reduction threshold for the second TTI, or both.

In some examples, the uplink throughput threshold associated with the first TTI is selectively adjusted to the additional uplink throughput threshold based on the UE refraining from transmitting within the second set of resources of the second carrier during the first TTI.

In some examples, the additional uplink throughput threshold evaluated during the second TTI is different from the uplink throughput threshold evaluated during the first TTI based on one or more parameters associated with the one or more uplink messages scheduled to be communicated within the first TTI and the second TTI.

In some examples, the one or more parameters include an RV associated with the one or more uplink messages scheduled to be communicated within second TTI.

In some examples, the request manager 750 is capable of, configured to, or operable to support a means for transmitting a request for the network entity to adjust the resource allocation based on refraining from transmitting within the second set of resources. In some examples, the resource allocation manager 730 is capable of, configured to, or operable to support a means for receiving a second resource allocation from the network entity based on the request, where the second resource allocation includes resources within a single carrier, or includes resources within the first carrier and a third carrier.

Additionally, or alternatively, the communications manager 720 may support wireless communications in accordance with examples as disclosed herein. In some examples, the resource allocation manager 730 is capable of, configured to, or operable to support a means for receiving, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources. The RLF manager 740 is capable of, configured to, or operable to support a means for transmitting, to the network entity, an uplink message indicating an RLF associated with the second carrier based on the second throughput contribution of the second carrier failing to satisfy an uplink throughput threshold, and based on a downlink contribution of the second carrier failing to satisfy a downlink throughput threshold. In some examples, the uplink communications manager 735 is capable of, configured to, or operable to support a means for transmitting the one or more uplink messages within the first set of resources of the first carrier based on the resource allocation and the uplink message.

In some examples, the power reduction configuration manager 725 is capable of, configured to, or operable to support a means for receiving, via the control signaling, additional control signaling, or both, a power reduction configuration associated with uplink communications performed by the UE within aggregated carriers, where transmitting the uplink message indicating the RLF is based on a power reduction value of the first carrier being greater than or equal to a power reduction threshold.

In some examples, the uplink communications manager 735 is capable of, configured to, or operable to support a means for transmitting the one or more uplink messages within the first set of resources of the first carrier in accordance with a second power reduction value that is different from the power reduction value based on transmitting the uplink message indicating the RLF associated with the second carrier.

In some examples, the second power reduction value is associated with a higher Tx power as compared to the power reduction value.

In some examples, the power reduction configuration manager 725 is capable of, configured to, or operable to support a means for receiving, via the control signaling, the additional control signaling, or both, an indication of the power reduction threshold, where transmitting the uplink message indicating the RLF is based on receiving the indication of the power reduction threshold.

In some examples, the uplink throughput manager 745 is capable of, configured to, or operable to support a means for receiving, via the control signaling, additional control signaling, or both, an indication of the uplink throughput threshold, the downlink throughput threshold, or both, where transmitting the uplink message indicating the RLF is based on receiving the indication of the uplink throughput threshold, the downlink throughput threshold, or both.

In some examples, the uplink message includes a channel quality information report associated with the second carrier.

In some examples, the uplink message indicates the RLF for each of the set of multiple TTIs.

In some examples, to support transmitting the uplink message indicating an RLF, the SRS manager 755 is capable of, configured to, or operable to support a means for transmitting one or more SRSs with a degraded Tx power via one or more resource blocks associated with the second carrier.

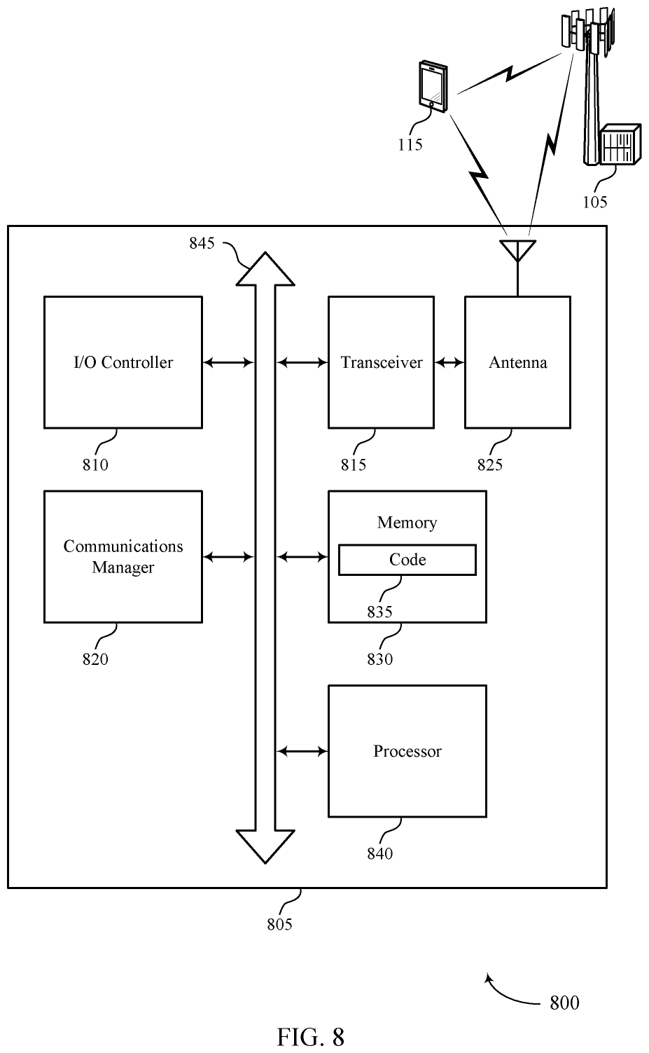

FIG. 8 shows a diagram of a system 800 including a device 805 that supports techniques for ULCA communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for ULCA communications). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communications in accordance with examples as disclosed herein. For example, the communications manager 820 is capable of, configured to, or operable to support a means for receiving, from a network entity, control signaling indicating a power reduction configuration associated with uplink communications performed by the UE within aggregated carriers. The communications manager 820 is capable of, configured to, or operable to support a means for receiving, via the control signaling, additional control signaling, or both, a resource allocation for communicating one or more uplink messages across a set of multiple TTIs within a first carrier and a second carrier, where the resource allocation includes a first set of resources within the first carrier and a second set of resources within the second carrier. The communications manager 820 is capable of, configured to, or operable to support a means for transmitting, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI.

Additionally, or alternatively, the communications manager 820 may support wireless communications in accordance with examples as disclosed herein. For example, the communications manager 820 is capable of, configured to, or operable to support a means for receiving, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources. The communications manager 820 is capable of, configured to, or operable to support a means for transmitting, to the network entity, an uplink message indicating an RLF associated with the second carrier based on the second throughput contribution of the second carrier failing to satisfy an uplink throughput threshold, and based on a downlink contribution of the second carrier failing to satisfy a downlink throughput threshold. The communications manager 820 is capable of, configured to, or operable to support a means for transmitting the one or more uplink messages within the first set of resources of the first carrier based on the resource allocation and the uplink message.

By including or configuring the communications manager 820 in accordance with examples as described herein, the device 805 may support techniques that enable more efficient and effective ULCA communications. In particular, techniques described herein may enable UEs 115 to perform ULCA communications when such ULCA communications result in increased throughput and/or uplink data capacity, but to drop back down to single-carrier communications (and/or modified ULCA configurations) when such ULCA communications require high MPR values that restrict network coverage or uplink throughput/capacity. As such, aspects of the present disclosure enable more dynamic ULCA communications where wireless devices are able to evaluate whether or not such ULCA communications will result in increased throughput or performance.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for ULCA communications as described herein, or the at least one processor 840 and the at least one memory 830 may be otherwise configured to, individually or collectively, perform or support such operations.

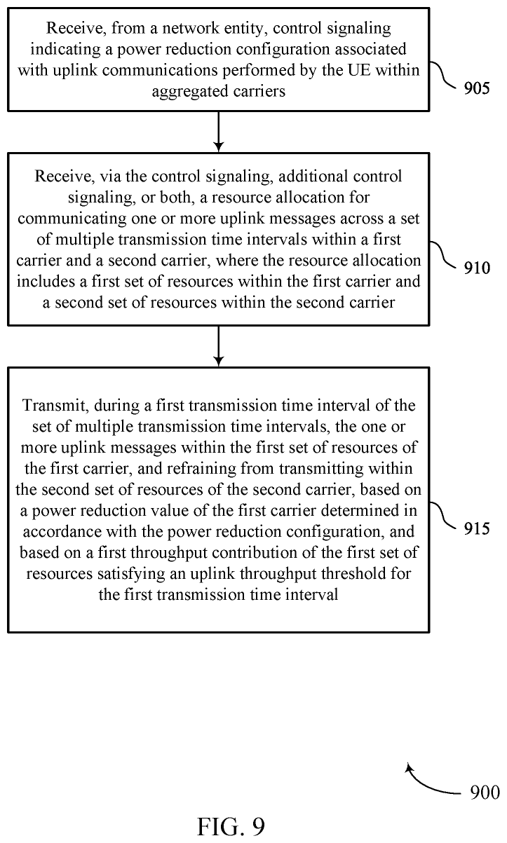

FIG. 9 shows a flowchart illustrating a method 900 that supports techniques for ULCA communications in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, from a network entity, control signaling indicating a power reduction configuration associated with uplink communications performed by the UE within aggregated carriers. The operations of block 905 may be performed in accordance with examples as disclosed herein. In some examples, aspects of the operations of 905 may be performed by a power reduction configuration manager 725 as described with reference to FIG. 7.

At 910, the method may include receiving, via the control signaling, additional control signaling, or both, a resource allocation for communicating one or more uplink messages across a set of multiple TTIs within a first carrier and a second carrier, where the resource allocation includes a first set of resources within the first carrier and a second set of resources within the second carrier. The operations of block 910 may be performed in accordance with examples as disclosed herein. In some examples, aspects of the operations of 910 may be performed by a resource allocation manager 730 as described with reference to FIG. 7.

At 915, the method may include transmitting, during a first TTI of the set of multiple TTIs, the one or more uplink messages within the first set of resources of the first carrier, and refraining from transmitting within the second set of resources of the second carrier, based on a power reduction value of the first carrier determined in accordance with the power reduction configuration, and based on a first throughput contribution of the first set of resources satisfying an uplink throughput threshold for the first TTI. The operations of block 915 may be performed in accordance with examples as disclosed herein. In some examples, aspects of the operations of 915 may be performed by an uplink communications manager 735 as described with reference to FIG. 7.

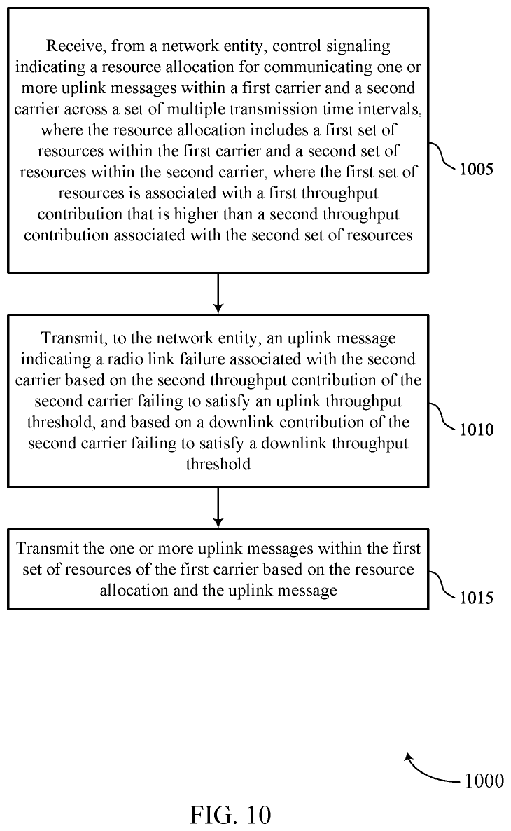

FIG. 10 shows a flowchart illustrating a method 1000 that supports techniques for ULCA communications in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, from a network entity, control signaling indicating a resource allocation for communicating one or more uplink messages within a first carrier and a second carrier across a set of multiple TTIs, where the resource allocation includes a first set of resources within the first carrier and a second set of resources within the second carrier, where the first set of resources is associated with a first throughput contribution that is higher than a second throughput contribution associated with the second set of resources. The operations of block 1005 may be performed in accordance with examples as disclosed herein. In some examples, aspects of the operations of 1005 may be performed by a resource allocation manager 730 as described with reference to FIG. 7.

At 1010, the method may include transmitting, to the network entity, an uplink message indicating an RLF associated with the second carrier based on the second throughput contribution of the second carrier failing to satisfy an uplink throughput threshold, and based on a downlink contribution of the second carrier failing to satisfy a downlink throughput threshold. The operations of block 1010 may be performed in accordance with examples as disclosed herein. In some examples, aspects of the operations of 1010 may be performed by an RLF manager 740 as described with reference to FIG. 7.

At 1015, the method may include transmitting the one or more uplink messages within the first set of resources of the first carrier based on the resource allocation and the uplink message. The operations of block 1015 may be performed in accordance with examples as disclosed herein. In some examples, aspects of the operations of 1015 may be performed by an uplink communications manager 735 as described with reference to FIG. 7.

The following provides an overview of aspects of the present disclosure:

Aspect 1: A method for wireless communications at a UE, comprising: receiving, from a network entity, control signaling indicating a power reduction configuration associated with uplink communications performed by the UE within aggregated carriers; receiving, via the control signaling, additional control signaling, or both, a resource allocation for communicating one or more uplink messages across a plurality of TTIs within a first carrier and a second carrier, wherein the resource allocation comprises a first set of resources within the first carrier and a second set of resources within the second carrier; and transmitting, during a first TTI of the plurality of TTIs, the one or more uplink messages within the first set of resources of the first carrier, and refraining from transmitting within the second set of resources of the second carrier, based at least in part on a power reduction value of the first carrier determined in accordance with the power reduction configuration, and based at least in part on a first throughput contribution of the first set of resources satisfying an uplink throughput threshold for the first TTI.

Aspect 2: The method of aspect 1, further comprising: transmitting the one or more uplink messages within the first carrier in accordance with a second power reduction value that is different from the power reduction value based at least in part on refraining from transmitting within the second set of resources.

Aspect 3: The method of aspect 2, wherein the second power reduction value is associated with a higher transmit power as compared to the power reduction value.

Aspect 4: The method of any of aspects 1 through 3, wherein transmitting the one or more uplink messages within the first set of resources, and refraining from transmitting within the second set of resources, is based at least in part on the power reduction value of the first carrier being greater than or equal to a power reduction threshold.

Aspect 5: The method of aspect 4, wherein transmitting the one or more uplink messages within the first set of resources, and refraining from transmitting within the second set of resources, is based at least in part on the first throughput contribution associated with the first carrier being greater than a second throughput contribution associated with the second carrier during the first TTI of the plurality of TTIs.

Aspect 6: The method of aspect 5, wherein the first throughput contribution and the second throughput contribution are based at least in part on quantities of resource blocks included within the first set of resources and the second set of resources, respectively, a MCS associated with the first carrier or the second carrier, a BLER associated with the first carrier or the second carrier, or any combination thereof.

Aspect 7: The method of any of aspects 4 through 6, further comprising: receiving, via the control signaling, the additional control signaling, or both, an indication of the power reduction threshold.

Aspect 8: The method of any of aspects 1 through 7, further comprising: receiving, via the control signaling, the additional control signaling, or both, an indication of the uplink throughput threshold.

Aspect 9: The method of any of aspects 1 through 8, further comprising: transmitting, during a second TTI of the plurality of TTIs, one or more additional uplink messages within the first set of resources of the first carrier and the second set of resources of the second carrier based at least in part on a second throughput contribution of the first set of resources failing to satisfy the uplink throughput threshold, an additional uplink throughput threshold, or both, for the second TTI, based at least in part on a power reduction value of the first carrier failing to satisfy a power reduction threshold for the second TTI, or both.

Aspect 10: The method of aspect 9, wherein the uplink throughput threshold associated with the first TTI is selectively adjusted to the additional uplink throughput threshold based at least in part on the UE refraining from transmitting within the second set of resources of the second carrier during the first TTI.

Aspect 11: The method of any of aspects 9 through 10, wherein the additional uplink throughput threshold evaluated during the second TTI is different from the uplink throughput threshold evaluated during the first TTI based at least in part on one or more parameters associated with the one or more uplink messages scheduled to be communicated within the first TTI and the second TTI.

Aspect 12: The method of aspect 11, wherein the one or more parameters comprise an RV associated with the one or more uplink messages scheduled to be communicated within second TTI.

Aspect 13: The method of any of aspects 1 through 12, further comprising: transmitting a request for the network entity to adjust the resource allocation based at least in part on refraining from transmitting within the second set of resources; and receiving a second resource allocation from the network entity based at least in part on the request, wherein the second resource allocation comprises resources within a single carrier, or comprises resources within the first carrier and a third carrier.

Aspect 14: A method for wireless communications at a UE, comprising: receiving, from a network entity, control signaling indicating a resource allocation for communicating one or more uplink messages within a first carrier and a second carrier across a plurality of TTIs, wherein the resource allocation comprises a first set of resources within the first carrier and a second set of resources within the second carrier, wherein the first set of resources is associated with a first throughput contribution that is higher than a second throughput contribution associated with the second set of resources; transmitting, to the network entity, an uplink message indicating a radio link failure associated with the second carrier based at least in part on the second throughput contribution of the second carrier failing to satisfy an uplink throughput threshold, and based at least in part on a downlink contribution of the second carrier failing to satisfy a downlink throughput threshold; and transmitting the one or more uplink messages within the first set of resources of the first carrier based at least in part on the resource allocation and the uplink message.

Aspect 15: The method of aspect 14, further comprising: receiving, via the control signaling, additional control signaling, or both, a power reduction configuration associated with uplink communications performed by the UE within aggregated carriers, wherein transmitting the uplink message indicating the radio link failure is based at least in part on a power reduction value of the first carrier being greater than or equal to a power reduction threshold.

Aspect 16: The method of aspect 15, further comprising: transmitting the one or more uplink messages within the first set of resources of the first carrier in accordance with a second power reduction value that is different from the power reduction value based at least in part on transmitting the uplink message indicating the radio link failure associated with the second carrier.

Aspect 17: The method of aspect 16, wherein the second power reduction value is associated with a higher transmit power as compared to the power reduction value.

Aspect 18: The method of any of aspects 15 through 17, further comprising: receiving, via the control signaling, the additional control signaling, or both, an indication of the power reduction threshold, wherein transmitting the uplink message indicating the radio link failure is based at least in part on receiving the indication of the power reduction threshold.

Aspect 19: The method of any of aspects 14 through 18, further comprising: receiving, via the control signaling, additional control signaling, or both, an indication of the uplink throughput threshold, the downlink throughput threshold, or both, wherein transmitting the uplink message indicating the radio link failure is based at least in part on receiving the indication of the uplink throughput threshold, the downlink throughput threshold, or both.

Aspect 20: The method of any of aspects 14 through 19, wherein the uplink message comprises a channel quality information report associated with the second carrier.

Aspect 21: The method of any of aspects 14 through 20, wherein the uplink message indicates the radio link failure for each of the plurality of TTIs.

Aspect 22: The method of any of aspects 14 through 21, wherein transmitting the uplink message indicating a radio link failure comprises: transmitting one or more sounding reference signals with a degraded transmit power via one or more resource blocks associated with the second carrier.

Aspect 23: A UE for wireless communications, comprising one or more memories storing processor-executable code, and one or more processors coupled with the one or more memories and individually or collectively operable to execute the code to cause the UE to perform a method of any of aspects 1 through 13.

Aspect 24: A UE for wireless communications, comprising at least one means for performing a method of any of aspects 1 through 13.

Aspect 25: A non-transitory computer-readable medium storing code for wireless communications, the code comprising instructions executable by a processor to perform a method of any of aspects 1 through 13.

Aspect 26: A UE for wireless communications, comprising one or more memories storing processor-executable code, and one or more processors coupled with the one or more memories and individually or collectively operable to execute the code to cause the UE to perform a method of any of aspects 14 through 22.

Aspect 27: A UE for wireless communications, comprising at least one means for performing a method of any of aspects 14 through 22.

Aspect 28: A non-transitory computer-readable medium storing code for wireless communications, the code comprising instructions executable by a processor to perform a method of any of aspects 14 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, control signaling indicating a power reduction configuration associated with uplink communications performed by the UE within aggregated carriers;
receive, via the control signaling, additional control signaling, or both, a resource allocation for communicating one or more uplink messages across a plurality of transmission time intervals within a first carrier and a second carrier, wherein the resource allocation comprises a first set of resources within the first carrier and a second set of resources within the second carrier; and
transmit, during a first transmission time interval of the plurality of transmission time intervals, the one or more uplink messages within the first set of resources of the first carrier, and refrain from transmitting within the second set of resources of the second carrier, based at least in part on a power reduction value of the first carrier determined in accordance with the power reduction configuration, and based at least in part on a first throughput contribution of the first set of resources satisfying an uplink throughput threshold for the first transmission time interval.

2. The UE of claim 1, wherein the one or more processors are individually or collectively further operable to execute the code to cause the UE to:
transmit the one or more uplink messages within the first carrier in accordance with a second power reduction value that is different from the power reduction value based at least in part on refraining from transmitting within the second set of resources.

3. The UE of claim 2, wherein the second power reduction value is associated with a higher transmit power as compared to the power reduction value.

4. The UE of claim 1, wherein transmitting the one or more uplink messages within the first set of resources, and refraining from transmitting within the second set of resources, is based at least in part on the power reduction value of the first carrier being greater than or equal to a power reduction threshold.

5. The UE of claim 4, wherein transmitting the one or more uplink messages within the first set of resources, and refraining from transmitting within the second set of resources, is based at least in part on the first throughput contribution associated with the first carrier being greater than a second throughput contribution associated with the second carrier during the first transmission time interval of the plurality of transmission time intervals.

6. The UE of claim 5, wherein the first throughput contribution and the second throughput contribution are based at least in part on quantities of resource blocks included within the first set of resources and the second set of resources, respectively, a modulation and coding scheme associated with the first carrier or the second carrier, a block error rate associated with the first carrier or the second carrier, or any combination thereof.

7. The UE of claim 4, wherein the one or more processors are individually or collectively further operable to execute the code to cause the UE to:
receive, via the control signaling, the additional control signaling, or both, an indication of the power reduction threshold.

8. The UE of claim 1, wherein the one or more processors are individually or collectively further operable to execute the code to cause the UE to:
receive, via the control signaling, the additional control signaling, or both, an indication of the uplink throughput threshold.

9. The UE of claim 1, wherein the one or more processors are individually or collectively further operable to execute the code to cause the UE to:
transmit, during a second transmission time interval of the plurality of transmission time intervals, one or more additional uplink messages within the first set of resources of the first carrier and the second set of resources of the second carrier based at least in part on a second throughput contribution of the first set of resources failing to satisfy the uplink throughput threshold, an additional uplink throughput threshold, or both, for the second transmission time interval, based at least in part on a power reduction value of the first carrier failing to satisfy a power reduction threshold for the second transmission time interval, or both.

10. The UE of claim 9, wherein the uplink throughput threshold associated with the first transmission time interval is selectively adjusted to the additional uplink throughput threshold based at least in part on the UE refraining from transmitting within the second set of resources of the second carrier during the first transmission time interval.

11. The UE of claim 9, wherein the additional uplink throughput threshold evaluated during the second transmission time interval is different from the uplink throughput threshold evaluated during the first transmission time interval based at least in part on one or more parameters associated with the one or more uplink messages scheduled to be communicated within the first transmission time interval and the second transmission time interval.

12. The UE of claim 11, wherein the one or more parameters comprise a redundancy version associated with the one or more uplink messages scheduled to be communicated within second transmission time interval.

13. The UE of claim 1, wherein the one or more processors are individually or collectively further operable to execute the code to cause the UE to:
transmit a request for the network entity to adjust the resource allocation based at least in part on refraining from transmitting within the second set of resources; and
receive a second resource allocation from the network entity based at least in part on the request, wherein the second resource allocation comprises resources within a single carrier, or comprises resources within the first carrier and a third carrier.

14. A user equipment (UE), comprising:
one or more memories storing processor-executable code; and
one or more processors coupled with the one or more memories and individually or collectively operable to execute the code to cause the UE to:
receive, from a network entity, control signaling indicating a resource allocation for communicating one or more uplink messages within a first carrier and a second carrier across a plurality of transmission time intervals, wherein the resource allocation comprises a first set of resources within the first carrier and a second set of resources within the second carrier, wherein the first set of resources is associated with a first throughput contribution that is higher than a second throughput contribution associated with the second set of resources;
transmit, to the network entity, an uplink message indicating a radio link failure associated with the second carrier based at least in part on the second throughput contribution of the second carrier failing to satisfy an uplink throughput threshold, and based at least in part on a downlink contribution of the second carrier failing to satisfy a downlink throughput threshold; and
transmit the one or more uplink messages within the first set of resources of the first carrier based at least in part on the resource allocation and the uplink message.

15. The UE of claim 14, wherein the one or more processors are individually or collectively further operable to execute the code to cause the UE to:
receive, via the control signaling, additional control signaling, or both, a power reduction configuration associated with uplink communications performed by the UE within aggregated carriers, wherein transmitting the uplink message indicating the radio link failure is based at least in part on a power reduction value of the first carrier being greater than or equal to a power reduction threshold.

16. The UE of claim 15, wherein the one or more processors are individually or collectively further operable to execute the code to cause the UE to:
transmit the one or more uplink messages within the first set of resources of the first carrier in accordance with a second power reduction value that is different from the power reduction value based at least in part on transmitting the uplink message indicating the radio link failure associated with the second carrier.

17. The UE of claim 16, wherein the second power reduction value is associated with a higher transmit power as compared to the power reduction value.

18. The UE of claim 15, wherein the one or more processors are individually or collectively further operable to execute the code to cause the UE to:
receive, via the control signaling, the additional control signaling, or both, an indication of the power reduction threshold, wherein transmitting the uplink message indicating the radio link failure is based at least in part on receiving the indication of the power reduction threshold.

19. The UE of claim 14, wherein the one or more processors are individually or collectively further operable to execute the code to cause the UE to:
receive, via the control signaling, additional control signaling, or both, an indication of the uplink throughput threshold, the downlink throughput threshold, or both, wherein transmitting the uplink message indicating the radio link failure is based at least in part on receiving the indication of the uplink throughput threshold, the downlink throughput threshold, or both.

20. The UE of claim 14, wherein the uplink message comprises a channel quality information report associated with the second carrier.

21. The UE of claim 14, wherein the uplink message indicates the radio link failure for each of the plurality of transmission time intervals.

22. The UE of claim 14, wherein, to transmit the uplink message indicating a radio link failure, the one or more processors are individually or collectively operable to execute the code to cause the UE to:
transmit one or more sounding reference signals with a degraded transmit power via one or more resource blocks associated with the second carrier.

23. A method for wireless communications at a user equipment (UE), comprising:
receiving, from a network entity, control signaling indicating a power reduction configuration associated with uplink communications performed by the UE within aggregated carriers;
receiving, via the control signaling, additional control signaling, or both, a resource allocation for communicating one or more uplink messages across a plurality of transmission time intervals within a first carrier and a second carrier, wherein the resource allocation comprises a first set of resources within the first carrier and a second set of resources within the second carrier; and
transmitting, during a first transmission time interval of the plurality of transmission time intervals, the one or more uplink messages within the first set of resources of the first carrier, and refraining from transmitting within the second set of resources of the second carrier, based at least in part on a power reduction value of the first carrier determined in accordance with the power reduction configuration, and based at least in part on a first throughput contribution of the first set of resources satisfying an uplink throughput threshold for the first transmission time interval.

24. The method of claim 23, further comprising:
transmitting the one or more uplink messages within the first carrier in accordance with a second power reduction value that is different from the power reduction value based at least in part on refraining from transmitting within the second set of resources.

25. The method of claim 24, wherein the second power reduction value is associated with a higher transmit power as compared to the power reduction value.

26. The method of claim 23, wherein transmitting the one or more uplink messages within the first set of resources, and refraining from transmitting within the second set of resources, is based at least in part on the power reduction value of the first carrier being greater than or equal to a power reduction threshold.

27. The method of claim 26, wherein transmitting the one or more uplink messages within the first set of resources, and refraining from transmitting within the second set of resources, is based at least in part on the first throughput contribution associated with the first carrier being greater than a second throughput contribution associated with the second carrier during the first transmission time interval of the plurality of transmission time intervals.

28. The method of claim 27, wherein the first throughput contribution and the second throughput contribution are based at least in part on quantities of resource blocks included within the first set of resources and the second set of resources, respectively, a modulation and coding scheme associated with the first carrier or the second carrier, a block error rate associated with the first carrier or the second carrier, or any combination thereof.

29. The method of claim 26, further comprising:
receiving, via the control signaling, the additional control signaling, or both, an indication of the power reduction threshold.

30. A method for wireless communications at a user equipment (UE), comprising:
receiving, from a network entity, control signaling indicating a resource allocation for communicating one or more uplink messages within a first carrier and a second carrier across a plurality of transmission time intervals, wherein the resource allocation comprises a first set of resources within the first carrier and a second set of resources within the second carrier, wherein the first set of resources is associated with a first throughput contribution that is higher than a second throughput contribution associated with the second set of resources;
transmitting, to the network entity, an uplink message indicating a radio link failure associated with the second carrier based at least in part on the second throughput contribution of the second carrier failing to satisfy an uplink throughput threshold, and based at least in part on a downlink contribution of the second carrier failing to satisfy a downlink throughput threshold; and
transmitting the one or more uplink messages within the first set of resources of the first carrier based at least in part on the resource allocation and the uplink message.
